(19) United States
(12) Patent Application Publication
(10) Pub. No.: US 2013/0275894 A1
(43) Pub. Date: Oct. 17, 2013

(54) METHOD AND SYSTEM FOR SHARING OBJECT INFORMATION

(71) Applicant: BIRDS IN THE HAND, LLC, (US)

(72) Inventors: David A. Bell, Altadena, CA (US); Lon E. Bell, Altadena, CA (US); John Peterson Myers, Crozet, VA (US); Richard Christopher DeCharms, Half Moon Bay, CA (US)

(73) Assignee: BIRDS IN THE HAND, LLC, Pasadena, CA (US)

(21) Appl. No.: 13/719,118

(22) Filed: Dec. 18, 2012

Related U.S. Application Data
(60) Provisional application No. 61/577,520, filed on Dec. 19, 2011.

(51) Int. Cl. G06F 3/0481

(52) U.S. Cl. CPC G06F 3/0481
USPC 715/764

(57) ABSTRACT

Methods and systems of locating and identifying categories of biological objects are discussed herein. In one aspect, a system configured to locate and identify categories of biological objects at a geographical location includes obtaining a visual or an aural characteristic of one or more biological objects sighted, comparing the obtained visual or aural characteristic with visual or aural characteristics of known biological objects stored in a database and identifying the one or more known biological objects that closely match the one or more biological objects sighted. In another aspect, a system that allows a user to efficiently record sightings of biological objects is disclosed. The system is configured to display a list of biological objects arranged based on likelihood of occurrence of biological objects in a geographical location for the user to select from.

### CROSS-REFERENCE TO RELATED APPLICATIONS

This application claims the benefit under 35 U.S.C. §119(e) of U.S. Provisional Patent Application No. 61/577,520 filed Dec. 19, 2011, entitled “METHOD AND SYSTEM FOR SHARING OBJECT INFORMATION,” which is incorporated by reference herein in its entirety.

### BACKGROUND

1. Field of the Invention

This application relates to systems and methods for recording and sharing information regarding sightings or observations of objects and biological objects in particular.

2. Summary

Systems and methods described herein aid a user to identify and report the occurrence or absence of macroscopic biological objects of interest to hobbyists or scientists such as birds, insects, reptiles, flowers, seeds, trees, grasses, bushes, reeds, sedges, ferns, arachnids, amphibians, mammals, marine animals fish, other animals, other plants, other sea life; and to receive and manage such reports from others. The systems and methods described herein can also be used to report information related to local and regional weather patterns, local and regional news events, information related to local and regional instances of public health, etc.

The systems, methods and devices of the disclosure each have several innovative aspects, no single one of which is solely responsible for the desirable attributes disclosed herein.

Some innovative aspects of the subject matter described in this disclosure can be implemented in a system for generating and displaying object information. The system can enable a user to enter information associated with a biological object. Various implementations of the system include a physical computer processor configured to provide at least one list of categories of biological objects to the user, accept user input indicating selection of at least one category of biological object from the provided list, and generate an electronic record including the at least one category of biological object. In various implementations, the input from the user can include at least one of an alpha-numeric character, an icon and a voice command. In various implementations, the processor can be configured to transmit the generated electronic record to at least one remote network element using an electronic communication system. In various implementations, the system can be configured to accept user input authorizing sharing at least a portion of the information included in the electronic record with one or more different users or an electronic database prior to transmitting the generated electronic record.

In various implementations, the at least one list can be generated based on one or more of the following parameters: geographical location, time of the day, time of the year, past records associated with the occurrence of the at least one category of biological object at the geographical location, past records associated with the occurrence of the at least one category of biological object at the observation time or date, abundance of the at least one category of biological object in previous years at the observation time or date at the geographical location, a spatial or temporal correlation of the at least one category of biological object with at least one other category of biological object that is known to occur at the geographical location at the observation time or date, a spatial or temporal correlation of the at least one category of biological object with a natural event that occurs at the geographical location, recent observations of the at least one category of biological object at the geographical location at the observation time or date, a spatial or temporal correlation of the at least one biological object with at least one of habitat, microclimate and weather, and user preference. In various implementations, the items of the at least one list of categories of biological objects are arranged in accordance with an increasing or decreasing likelihood of occurrence in a geographical location. The geographical location can encompass an area surrounding the user. In various implementations, the at least one list can be generated in real-time as well as provided to the user in real-time. In various implementations, the at least one list can be generated in response to at least one alpha-numeric character, icon or voice command provided by the user.

In various implementations numerical information can be associated with the at least one category of biological object in the electronic record. The numerical information can include a count, a percentage, or a rating. In various implementations of the system, the processor can be configured to request additional information or confirmation if the associated numerical information is less than or greater than a threshold value. The threshold value can be determined by an adaptive process or a real-time process. For example, the threshold value can be determined based upon an adaptive process that uses information about the spatial or temporal correlations of the occurrence of biological objects recently reported by the user with the occurrence of other biological objects. The additional information or confirmation can be obtained in real-time. The additional information or confirmation can be provided by the user. The additional information or confirmation can be provided using at least one alpha-numeric character, icon or a voice command.

Some innovative aspects of the subject matter described in this disclosure can be implemented in a method for generating and displaying object information. The method can enable a user to enter information associated with a biological object. The method can include: presenting a at least one list of categories of biological objects to the user; accepting user input indicating selection of at least one category of biological object from the presented list; and generating an electronic record including the at least one category of biological object, wherein the method is implemented by a physical computer processor. In various implementations, the method can allow the user to modify, control or limit the information displayed in the at least one list. In various implementations, the method can include transmitting the at least one generated electronic record using an electronic transmission system.

Some innovative aspects of the subject matter described in this disclosure can be implemented in a system configured to locate one or more biological object. Various implementations of the system include at least one sound transducer, a display device, and a processing system. The processing system is configured to receive sound information from the at least one transducer and detect in the sound information a first sound event from an area surrounding the system. The processing system is further configured to determine a direction corresponding to an origin of the first sound event and display a visual indication of the first sound event on the display device by superimposing the visual indication over a view of the surrounding area displayed on the display device. The visual indication can be superimposed in a region of the displayed view that coincides with the determined direction.

Various implementations of the system can include at least one of a mobile device, a camera, a binocular, a gun sighting system, a spotting scope, a video camera, a telescope, night vision system, a mobile computing device or a smart phone. In various implementations, the sound transducer can include one or more microphones. In various implementations, the sound transducer can be disposed near or incorporate at least one of one or more baffles and/or one or more acoustic reflectors. The visual indication can include at least one of a shape, a colored region, a symbol and a region of increased brightness. The visual indication can persist for an interval of time after the occurrence of the first sound event. In various implementations, a brightness of the visual indication can decrease during the persistence interval. In various implementations, the processor can be configured to detect at least a second sound event and display at least the second sound event on the display device. The at least second sound event can occur simultaneously with the first sound event. Alternately, the at least second sound event can occur subsequent to the first sound event. In various implementations, the at least second sound event can originate from a direction different from the direction of origin of the first sound event. In various implementations, the processor can be configured to provide a list of categories of biological objects that produce the first sound event. In various implementations, the categories of biological objects in the list are arranged based on a decreasing order of likelihood of occurrence.

In various implementations, the processor can be configured to store the first sound event in a database. The processor can be further configured to output the stored first sound event to an electronic speaker. In various implementations, the system can include an imaging system configured to obtain the displayed view of the surrounding area. In various implementations, the system is configured to be in a surveillance mode to survey a region of the surrounding area.

Some innovative aspects of the subject matter described in this disclosure can be implemented in a system configured to locate and identify at least one biological object. The system includes an imaging system configured to obtain an image of a surrounding area and a physical computer processor. Various implementations of the system can include a sound transducer. The processor is configured to analyze a region of the obtained image to locate at least one biological object in the region, generate a list of possible categories of biological objects that closely match the at least one located biological object, and display the generated list on a display device in communication with the system. In various implementations, the list of possible categories of biological objects can be generated based on size, shape, visual characteristic that can be imaged, and movement information of the located biological objects. The list of possible categories of biological objects can be generated based on a sound event originating from the analyzed region and detected by the sound transducer. The list of possible categories of biological objects can be arranged in the order of decreasing likelihood of a match with the located biological object.

In various implementations, the system can include at least one of a mobile device, a camera, a binocular, a gun sighting system, a spotting scope, a video camera, a telescope, night vision system, a mobile computing device and a smart phone. In various implementations, the system can be configured to accept user input indicating selection of a portion of the region to be analyzed. In various implementations, the user input can correspond to a touch input.

Some innovative aspects of the subject matter described in this disclosure can be implemented in a method of identifying at least one biological object. The method includes receiving information associated with at least one biological object, receiving information associated with the identity of the at least one biological object from one or more sources; and selecting from among the received identity information one or more identities that closely match the identity of the at least one biological object. The method can be implemented by an electronic system including one or more physical processors. In various implementations, selecting one or more identities that closely match the identity of the at least one biological object is based at least in part on the geographical location associated with the at least one biological object. In various implementations, the one or more sources can include external databases, publicly available databases and catalogues of biological objects or one or more human identifiers. In various implementations, a routing algorithm can be used to distribute the received information of the at least one biological object to the one or more sources. In various implementations, a scoring algorithm can be used to establish identity of the at least one biological object. The scoring algorithm can include assigning a rank or score to each distinct identity in the received identity information; and selecting one or more of the distinct identities information with the based on the assigned rank or score.

Some innovative aspects of the subject matter described in this disclosure can be implemented in a method of identifying at least one biological object. The method includes providing an image to a user and accepting an input from the user, the input associated with an area of the provided image. The method further includes analyzing the area of the provided image to extract one or more visual characteristics of the at least one biological object present in the provided image, comparing the one or more extracted visual characteristics with visual characteristics of a plurality of categories of biological objects stored in an information store, and presenting a list of categories of biological objects that have visual characteristics similar to the one or more extracted visual characteristics. The method can be implemented by a physical computer processor.

In various implementations, comparing the one or more extracted visual characteristics with visual characteristics of a plurality of categories of biological objects can include matching the one or more extracted visual characteristics with the visual characteristics of at least a subset of the plurality of categories of biological objects in the information store, and calculating a score that indicates the closeness of the match. In various implementations, the list of categories of biological objects presented can be based on at least one of the calculated score and the geographical location of the image. In various implementations, the method can include transmitting the provided image to one or more external sources. In various implementations, the method can include accepting an input from the user. In various implementations, the input can be associated with a selection of a category of biological object from the presented list.

### BRIEF DESCRIPTION OF THE DRAWINGS

FIG. 1 illustrates a handheld system that can be used to identify biological object and/or be used to share information associated with sightings of the biological object.

FIGS. 2A and 2B illustrate an implementation of a method of sharing information associated with sightings/observations of the biological object.

FIGS. 3A-3L illustrate an implementation of a system configured to perform some of the operations performed by the method illustrated in FIGS. 2A and 2B.

FIGS. 4A-4C are implementations of the system showing visual indications representing sound events superimposed on displayed view of the surrounding.

FIG. 5 illustrates an implementation of the system in which portions of the incoming image information from the surrounding area are analyzed to locate and identify biological objects.

### DETAILED DESCRIPTION

Identifying biological objects includes assigning individual biological objects into correct categories of biological objects or in other words to associate them with the correct identity. To identify biological objects (e.g. birds, insects, reptiles, flowers, seeds, trees, grasses, bushes, reeds, sedges, ferns, arachnids, amphibians, mammals, marine animals fish, other animals, other plants, other sea life; and to receive and manage such reports from others, etc.), users (e.g. scientists, ornithologists, participants in Christmas Bird Counts, Great Backyard Bird Counts, Big Days or other group surveys, birdwatchers, hunters, botanists, hobbyists, biologists, biology field researchers, graduate students, eco-tourists, etc.) can refer to a guide book and use information included in the guide book to help identify the object. If some characteristic of the biological object (e.g. shape, color, pattern, voice signature, plumage, etc.) is recorded or observed, users can access information resources to identify and/or find out more information about the biological object based on the recorded/observed characteristic. Some users can additionally use location, time of year and day information to additionally aid in identifying the biological object. In some implementations, users can use keys, herbaria specimens, and other stored and cataloged information to identify the biological objects. In this manner, the knowledge organized, cataloged and stored previously can be used to assign biological objects that are observed into different categories. Categories of biological objects can include species, subspecies, races, morphs, forms, genera, families or any other taxonomic grouping; morphological groups based on morphological characteristics like morph, color, size or shape; functional groups based on habits such as raptors; sex; life cycle categories such as age, plumage, stage, larvae, egg; etc. For example, a biological object that is a bird could correctly be identified as a bird, a passerine bird, a member of the family Icteridae, an oriole, a Baltimore Oriole. Furthermore in this example the bird could be identified as an adult male Baltimore Oriole. In this description, the terms “biological object(s)” and “category(ies) of biological object(s)” are sometimes used interchangeably.

When users wish to record and/or share information associated with the biological object (e.g. observations of the biological object, counts, presence/absence, the sex, age, behavior, characteristics, context, habitat, health, or condition of the biological object, etc.) that they have observed, they can send such information to organizations or services that maintain local/regional/national/international databases or catalogues including such information, such as listservs, social media groups (e.g. Twitter or Facebook), discussion groups (e.g. Facebook groups, Google Groups or Yahoo! Groups) and specialized public databases like eBird.org. Currently users frequently employ tools like text message, email, web browsers or Facebook apps to share information associated with the biological object. Special-purpose tools for sharing observation information are also available, however, some of the available special-purpose tools may be less functional. Additionally, the shared information can be imprecise and prone to errors and/or ambiguity. Thus, a compact, portable, handheld system that could help the user to identify the biological object and share information associated with the biological object easily and in real-time can be useful. Additionally, a system that allows users to communicate or share information in a data format that permits rapid and accurate sharing of the essential information can be beneficial to a wide variety of users.

In various implementations users may wish to record and share information about lists or summaries of multiple different observations of biological objects, such as a list of birds observed on a Christmas Bird Count. This information can consist of one or more lists of biological objects observed or lists of categories of biological objects observed. In some implementations, users may wish to record and share information about the observation details, such as, for example, the amount of effort expended and/or the methods employed to make the observations. Again using a Christmas Count as an example, the user may wish to record and share a list of birds observed plus information about how many people participated in the birding party, the distances covered by the party by car, foot and boat, the time spent and the area covered. As a different example a user might wish to record or share a casual list of birds, mammals and reptiles observed during a multiple-week trip to East Africa. As another example a scientist might wish to record and publish a list of species of birds, mammals, reptiles, amphibians, plants, insects, etc. observed by many different observers during a multiple-year period for a large National Park. Accordingly, a system that allows users to recording and sharing one or more categories of biological objects observed and/or record and share lists of biological objects or details of multiple observations can be advantageous.

Users ability to access or use shared information associated with the biological object can be limited by the imprecise formatting and content of the shared information. Information typed by hand and shared via Facebook, Twitter, email, discussion group or listsery is normally available to the user as plain text. Errors, such as misspelling of the names of the biological objects, the locations of the sightings, the dates or times of the sightings, the name of the observer or the observation content are frequent, and make automatic searching and processing of the data difficult. Similarly, some information related to identification and/or accuracy of the observation may be omitted from this shared information, or is shared in a way that makes the intended meaning ambiguous. Systems that allow recording information associated with sightings of biological objects with increased accuracy and/or allow a user to easily and rapidly access the recorded information associated can be useful.

The systems and methods described in this application are provided with the capability to identify and/or share information associated with biological objects. The methods described herein can be implemented by systems that are compact and portable, for example, smart phones, tablet computers, mobile computing devices, PDAs, special-purpose handheld devices, etc. The methods described herein can also be implemented by systems that are not handheld, for example, special-purpose automatic devices, or on notebook, laptop or desktop computers, or any other suitable system. The methods described herein can also be implemented in systems that are located in kiosks or stations provided in zoos, national parks, nature preserves, eco-lodges, or any other suitable venue to identify various biological objects such as, for example, birds, insects, reptiles, flowers, seeds, trees, grasses, bushes, reeds, sedges, ferns, arachnids, amphibians, mammals, marine animals fish, other animals, other plants, other sea life; and to receive and manage such reports from others, etc. The methods disclosed herein can be implemented as an application for a smart phone (e.g. Android or iPhone) or a tablet computer (e.g. an iPad, Microsoft surface, etc.) that can be downloaded from an application store either free or for some form of payment (e.g. cash, credit, tokens, etc.). The methods described herein can also be implemented in systems that are built into or attached to other equipment carried with the user, such as hats, firearms, firearm sights, binoculars, spotting scopes, telescopes, mobile phones, smart phones, notebooks, pens, cameras, backpacks, specialty clothing, shoes or boots, or any other system, etc.

The system 100 that can be used to identify a biological object 101 and/or share information associated with the biological object 101 includes at least one electronic hardware processor and at least one information store (e.g. an electronic memory or a non-transitory computer readable medium). The electronic hardware processor is configured to execute instructions stored in a non-transitory computer readable medium included in the system 100 to locate, identify and/or share information associated with the biological object 101.

The system 100 also includes a display 113 that can display color, monochromatic, grayscale characters and/or images or by any other visual display system. The system 100 can optionally include an interface 109 that can be used to input information or to control the system 100. In various implementations, the interface 109 can include physical keyboard, one or more electronic switches, a touch-screen, voice recording systems, microphones, or some other mechanism to input information. In some implementations, the system 100 can display an on-screen touch keyboard to input information or control the system 100. The system 100 can include a communication system to allow the user to access information stored in information stores. The information stores can be internal to the system 100. For example, the information stores can include one or more memory devices integrated with the system 100. As another example, the information stores can be databanks maintained in other systems located remotely to the system 100. In various implementations, the information stores can include pattern recognition systems, catalogues or any other information source for easier and faster identification of the biological object 101 and/or sharing information associated with the biological object 101. In some implementations, the systems 100 can be capable of establishing communication with other human experts who can also aid in easier and faster identification of the biological object 101 and/or be interested in receiving information associated with the biological object 101. The systems 100 can include an electronic communication system 117 that can be used to share information associated with the biological object 101. In various implementations, the electronic communication system 117 can include a wireless communication system. In some implementations, the electronic communication system 117 can include wired communication system. In such implementations, the electronic communication system 117 can include an Ethernet cable or a USB cable.

In various implementations, the system 100 can include an image capture system (e.g. an imaging system 105 such as a camera or a lens) to capture photographs and/or videos of the biological object 101. In various implementations, the imaging system 105 can have IR (infra-red) or UV (ultraviolet) image capturing capability. In various implementations, the imaging system 105 can be configured as a differential polarization imaging system. In various implementations, the imaging system 105 can be configured to obtain images produced by different polarizations of light. In various implementations, the imaging system 105 can capture high-resolution images and videos. In various implementations, the imaging system 105 can have an enhanced zoom feature. In various implementations of the system 100, the imaging system 105 can be controlled by the interface 109 or a displayed touch screen control interface. In various implementations, the electronic communication system 117 can be configured to communicate with a global positioning system (GPS) that can determine the geographical location (latitude/longitude/altitude) of the user using the system 100. In some implementations, the system 100 can include or communicate with an altimeter that can determine the altitude and/or depth of the user using the system 100. In various implementations, the system 100 can include or communicate with a clock or other system that can provide the current date and time. In some implementations, the system 100 can include one or more sound transducers (e.g. microphones) 119 to record the sounds produced by the biological object 101 and/or to receive commands by voice and other input systems from the user. In various implementations, the system 100 can include baffles or reflectors around the one or more microphones to assist in mono-aural sound localization and/or directional filtering. In various implementations, the system 100 can include a speaker 121 that can be used to broadcast sounds toward the biological object 101. In various implementations, the speaker 121 can be a directional speaker. In various implementations, the system 100 can include or communicate with additional sensors (e.g. RF sensors, UV imaging systems, IR imaging systems, systems that detect and image differences in the polarization of light) and/or components that are known to a person having ordinary skill in the art to perform functions that may not be discussed herein but are known to a person having ordinary skill in the art. UV and polarization imaging systems can be useful in locating or identifying biological objects that are capable of detecting UV light or light having a specific polarization.

The system 100 can be designed to be rugged and/or weather-proof. In various implementations, the system 100 can include a hard protective case. In various implementations, the hard case can be light weight, shock proof, withstand high pressures, and capable of sustaining wide variation in temperature. Discussed below are some example functions that can be performed by and/or applications that can use the system 100 described above.

### Biological Object Data Entry

An aspect of the methods disclosed herein is to increase the accuracy, specificity, utility, speed and/or ease of sharing information by reducing the number of key strokes or other form of data entry used by the user to enter information associated with the biological object and thereby improve the information sharing process. A user can advantageously share information quickly, efficiently and economically using the system and methods discussed herein. For example, in various implementations the user can share information with users in the same or different geographical location in sufficiently real-time, such as, for example, in less than 30 seconds, in less than 1 minute, in less than 5 minutes, in less than 10 minutes, etc. As another example, a user can share information with other users in the same or different geographical location in using the system and methods discussed herein efficiently by using fewer characters in a text message. As yet another example, a user can share information with other users in the same or different geographical location in using the system and methods discussed herein economically by using less bandwidth. Another aspect of the systems and methods disclosed herein is to provide faster, easier and more accurate information sharing by providing the user a filtered list of likely biological objects that match the one or more biological objects observed to choose from. The list of likely biological objects can be filtered and/or sorted based on geographic location, time/date, sound characteristics, visual characteristics, and user-entered information like size, habitat and color. Another aspect of the implementations described herein is that the utility of the shared information is improved by using standardized coding for the shared information, which allows receivers of the shared information to employ automatic processing, decision-making and re-sharing of that shared information.

A user at a first geographical location can use the system 100 described above to share information associated with the biological object 101 observed at the first geographical location with one or more users at geographical locations that are different from the first geographical location. The user can choose to share the information with a specific other user, a specified group of other users, users meeting specified criteria, any other interested community or with the public. For example, the one or more users may be at geographical locations that are beyond the range of audible or visual communication from the user at the first geographical location, or the users may be near each other but in a place where audible communication is impractical or undesirable.

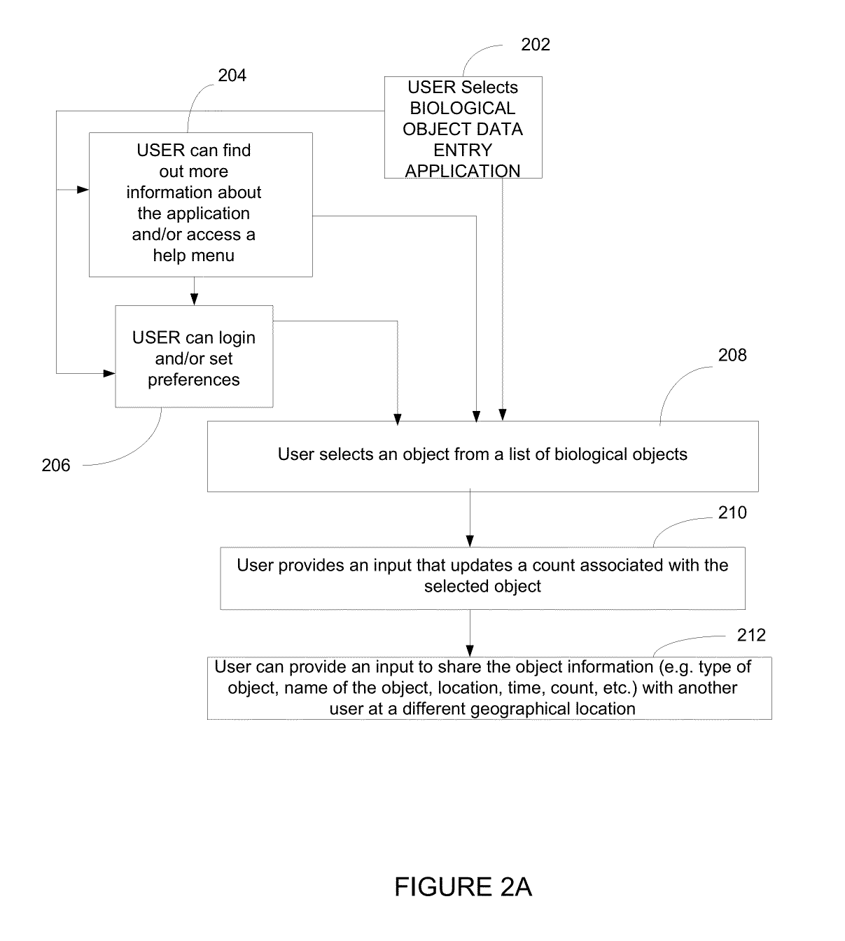

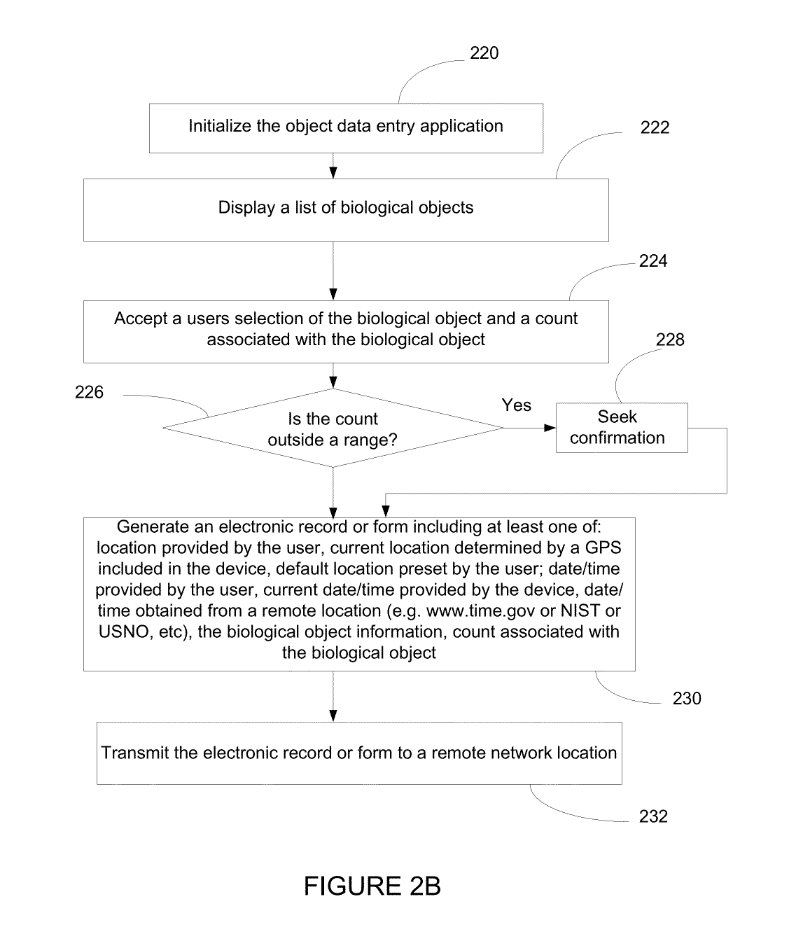

FIGS. 2A and 2B are flowcharts that illustrate implementations of a method used to share information associated with the biological object 101. When a user wishes to share information associated with a biological object 101 that he/she has observed or sighted, the user selects the biological object data entry application as shown in block 202 and accesses or enters the application. The biological object data entry application can be a standalone software application that is configured to be executed under the control of physical computer processor. Alternately, the biological object data entry application can be a feature included in the biological object identification and sharing application that is configured to be executed under the control of a physical computer processor. The application can include sub-menus that provide more information about the application, for example, version of the application, the platform used to create the application, an overview of the application, describe various features of the application or a help function to guide the user on how to use the application. The user can access these sub-menus as shown in block 204 upon accessing or entering the application. In various implementations, the user may be presented with a login screen as shown in block 206 upon accessing or entering the application. In such implementations, the user can register a login name and a password and set his/her preferences (e.g. real name, screen name, database credentials, default location, list of favorite biological objects, favorite method of sharing information, email address, display preferences, preferred users or groups to share information with, etc.) when he/she accesses or enters the application for the first time or at any other subsequent time. In various implementations, the application can remember the login name and password and skip the login screen when the user accesses or enters the application subsequently. However, in some implementations, the user may be prompted to confirm their login name and password each time he/she accesses or enters the application, so as to provide an increased level of security or to ensure that data is associated with the correct user. In various implementations, the user can register themselves at a website associated with the application and set their login name, password and preferences at the website.

In various implementations, the user may be requested to provide a geographical location and/or a time or date each time he/she accesses or enters the application. Alternately, the physical computer processor executing the application can receive the geographical location and/or a time or date information from the system 100 (e.g. from the internal clock of the system 100, from the GPS included in the system 100, or by accessing systems at remote location, for example, NIST, http://www.time.gov, or by any other method.). The user can select a biological object that matches the biological object 101 that the user has sighted or observed from a list of biological objects that is displayed to the user as shown in block 208. In various implementations, the list of biological objects can include a list of likely biological objects that can be found at the geographical location and time associated with the observation or sighting. For example, in one implementation, if the biological object category is birds, and the user has sighted or observed a Red-tailed Hawk, the user can select either the text including the words “Red-tailed Hawk” from the list of biological objects (e.g. birds) or a picture of the Red-tailed Hawk from the displayed list of biological objects (e.g. birds) or both. The determination of the list of biological objects (e.g. birds) is discussed in detail below. The user can provide an input that updates a count associated with the selected biological object (e.g. birds) as shown in block 210, or the count can be updated automatically. The user can additionally provide information associated with effort related to the biological object (e.g. birds) sighting or more information to confirm the sighting if requested. The user can provide the input by entering one or more alpha-numeric characters or voice commands or both. The user can then provide an input to share information associated with the biological object (e.g. birds) as shown in block 212. The user can share information associated with the observation/sighting of a single biological object 101 in real-time, for example, within a few seconds/minutes (e.g. 5 seconds, 1 minute, or 2 minutes) of observing or sighting the biological object 101. Alternately, the information provided by the user for one or more biological objects can be stored in an information store of the system 100 and shared at a later time, such as when the user returns home, finishes a survey, completes a transect, at the end of the quarter or year, etc. For example, in various implementations, the information can be shared within 1-4 hours, 1 day, 3 months, 6 months, or 1 year of observing or sighting the biological object 101. In various implementations, the information shared by the user can be used to update a database at a remote location. The information shared by the user can be posted as a twitter message, a Facebook status update, an email, a group discussion posting, a message to a listserv, a text message or a blog entry, or to any other appropriate location. In various implementations, the information shared by the user can be forwarded to one or more users at different geographical locations using a service, such as for example, special-purpose messaging within a receiving application, alarm, alert, text message, a short message service, email, voice phone or push notification services, or any other service.

The systems and methods described herein can be executed by a physical computer processor included in the system 100. The processor may execute some initialization processes when the user accesses or enters the application as shown in block 220. One of the initialization processes can include allocation of memory space in the information stores of the system 100. The processor can be configured obtain at least information about the effort expended in observing the biological objects. The effort information can include the number of observers, time, distance, area covered, geographical location information, altitude information, local and regional weather information, current time and date information, or other measures of effort. In various implementations, at least a portion of the effort information can be displayed to the user, included in the generated electronic record, recorded in an effort log or shared with one or more external sources. In various implementations, the processor can request the user to provide such effort information. The processor can accept the information provided by the user and store it in the information stores of the system 100.

In various implementations, the processor is configured to generate a list of biological objects to display to the user as shown in block 222 to reduce time taken and effort incurred by the user while sharing information about the biological object. In some implementations, the processor can display the list of biological objects right after the initialization process based on at least one of a current geographical location as determined by a GPS, a default geographical location provided by the user, an altitude as determined by an altimeter, GPS, or any other system, the current date and time, the current weather conditions, preferences set by the user, etc. In some implementations, the processor can display the list of biological objects in response to an input (e.g. at least one alphanumeric character, a picture, a voice, an icon, etc.) from the user such that the list matches at least a portion of the input. For example, if the user observes a Red-tailed Hawk and inputs the alphanumeric character “r,” then the processor can provide a list of all biological objects starting with the character “r,” such as, for example, Red-tailed Hawk, Rufous-tailed Hawk (a species found in Argentina and Chile), Ruby-throated Hummingbird, etc. The user can select the appropriate text from the displayed list of biological objects.

In various implementations, the displayed list of biological objects can be arranged based on the likelihood of occurrence of the biological object. For example, in the above example, if the user is located in at latitude 34.1 and longitude −118.2 in California, Red-tailed Hawk would appear first because its likelihood of occurrence in that part of California is greater than the Ruby-throated Hummingbird or the Rufous-tailed Hawk, while the Rufous-tailed Hawk would appear at the bottom of the list since it is not known to have been observed or sighted in California or North America. In various implementations, the biological object may be omitted from the displayed list of biological objects if its likelihood of occurrence is near zero. For example, in the above example, if the user is located in North America, then the Rufous-tailed Hawk may be omitted from the displayed list of biological objects since it has not been observed or sighted in North America so far. In various implementations, the likelihood of occurrence and/or the abundance of the biological object may be included in the list of biological objects displayed to the user. In various implementations, the list of biological objects can be filtered and/or sorted such that one or more biological objects that most likely match the biological objects sighted are provided toward the beginning of the list, while one or more biological objects that are less likely match the biological objects sighted are provided toward the end of the list to aid the user in proper identification of the sighted biological objects.

In various implementations, when the biological objects are birds, the processor may be adapted to accept codes such as, for example, standard bird banding association four-letter codes (e.g. BTYW for “Black-throated Gray Warbler”) from the user and display the corresponding name of the biological object to the user and/or input the corresponding name of the biological object in to an electronic record. In various implementations, the processor may be configured to wait until a minimum number of alphanumeric characters are input by the user before generating the list of biological objects that matches the alphanumeric characters input by the user. In various implementations, the minimum number of alphanumeric characters can be in the range of two to five. In various implementations, the processor may be adapted to designate, accept and/or recognize special characters such as, for example, “/”, “<”, “>”, “x”, “*”, “!” and associate them with names of the biological object, or specified combinations of special characters such as “*T”, or “*/”. For example, if the user inputs the string “WXGG”, the processor can display the bird “Western x Glaucous-winged Gull” or input the bird “Western x Glaucous-winged Gull” into an electronic record. Similarly and by way of example, if the user specified “*N” the processor can record that the bird's nest was observed. Similarly, “*” could demark the beginning of free-form text comment by the user, or have any other useful meaning. Similarly, “!” could demark that a biological object was searched for and not found. Similarly, “x” could demark that a biological object was present and “ ” could indicate that the object was not present.

The list of biological objects that is displayed to the user can be generated using at least one previously shared observation of the biological object, public database entries related to observations of the biological object, past records associated with the occurrence of the biological object in the geographical location associated with the user, past records associated with the occurrence of the biological object at the observation time or date, estimated, observed or calculated abundance of species in previous years at the observation time or date at or near the geographical location, an average of the estimated or observed abundance at nearby points, a spatial or temporal correlation of the abundance or occurrence of the biological object with another biological object of known occurrence or abundance at the geographical location at the observation time or date, a spatial or temporal correlation of the biological object with a natural event that occurs at the geographical location, a spatial or temporal correlation of the biological object with a natural habitat known or believed to exist at or near the geographical location, recent observations of the biological object at or near the geographical location at the observation time or date, a list of biological objects known to occur at a given location or in a given area, a list of biological objects known to occur in a geographical area during a given timeframe, or user preference. In various implementations, the processor can be configured to generate the list of biological objects by querying one or more external sources. In various implementations, the one or more external sources can include one or more servers, databases, systems or other data providers at one or more remote locations (for example, a server that hosts databases, catalogues and other sources of information including information associated with biological objects). In various implementations, the system can transmit information regarding the user's preferences and/or current geographic location and/or current date or time and/or current weather information, etc. to one or more remote locations. The one or more remote locations can generate a list of biological objects using the information provided by the processor and transmit information such as the generated list of biological objects to the processor to display to user. In various implementations, the one or more remote location can transmit other information of interest to user based on the information transmitted by the processor.

In various implementations, one or more lists of biological objects based on the users preferences, defaults and/or favorite locations may be generated in advance and stored on the information stores of the system 100 for easy access. In various implementations, the one or more lists of biological objects may be limited to one or more groups of taxa, such as birds, plants or insects, or may be limited further to sub-groups such as ducks, shrubs, butterflies, trees or flowering plants. In various implementations, the one or more lists of biological objects can be calculated in real-time in response to a request from the user to reflect the most recent changes to the database(s) using which the list of biological objects is generated. In various implementations, the one or more lists of biological objects may be provided by the organizers or sponsors of surveys, such as Christmas Bird Counts such as the one organized by the Audubon Society; the Great American Feederwatch; the Big Sit; or America's Birdiest County competitions. In various implementations, geographic location, time specific lists may be provided by the organizer, sponsor, arbiter or leader of birding competitions, such as county, State, National, ABA area or worldwide Big Year competitions, etc. In various implementations, a default list of biological objects may be used by the system that reflects the time or area in which the system is expected to be used. In various implementations, the parameters of the method for generating the one or more lists of biological objects may be based upon the usage patterns of the user, such as, for example, displaying species that the user frequently encounters, species of specific interest, species identified for tracking or any other list generated for such a purpose. In various implementations, the one or more lists of biological objects can be generated by taking into account other useful information such as, for example, movement information for various biological objects in a geographical location, migration patterns, etc.

In various implementations, the system 100 can transmit information regarding at least one of the location and time for which the list of biological objects is desired. In such implementations, the likelihood of abundance of biological objects in an area around the desired location can be calculated by querying one or more external source (e.g. various available public databases) and obtaining a count for each biological object sighted in the area around the desired location in a specified time interval. The obtained count for each biological object can be used as a measure of local abundance or likelihood. Biological objects having a count above a threshold can be included in the generated list of biological objects to be displayed to the user. In various implementations, the amount of information from the generated list of biological objects can be modified, limited or adapted before being displayed to the user. For example, in some implementations, only those biological objects that have characteristics specified by the user, such as color, size, habitat, behavior, shape, family, type, or any other commonly used characteristic familiar to people skilled at categorizing biological objects is displayed. As another example, in various implementations, only those biological objects whose occurrence is known or suspected to be statistically correlated with the occurrence of other biological objects that have been previously recorded by the user in the same location or time, such as, for example, biological objects that have been recently reported by the user in or near the current area is displayed to the user.

In one implementation, the list of biological objects is determined as follows: estimate the abundance or likelihood of occurrence for species that can be found in the location at that time of the day and year; and select the species with an estimated abundance or likelihood higher than a threshold. One method for calculating the estimated abundance or likelihood of occurrence of a species is as follows: a group of observations of those species that are located within 100 miles of the desired location and are present throughout the year is generated; the records are divided into years, and within each year they are divided into 52 groups depending on which week of the year they belong to; for each week within each year, the total observations of the species as a percentage of the total of all observations of all species are calculated, weighted by a function of distance (for example, 1/distance²) from the specified location and converted to a logarithmic scale; the resulting data for that year is smoothed by applying a smoothing function such as a least squares best fit to a functional form such as a terminated Fourier Series) to reduce the undesirable “noise” of the week-to-week variation while maintaining the integrity of the underlying seasonal pattern. This process is repeated for each year; an average for each week is computed by averaging the results for each of some number of previous years, such as 3, 5, etc. In some implementations, a mean and standard deviation for each week from the data for all years is calculated; an estimate of how the abundance in the most recent months or years differs from the long-term mean is calculated; this difference is expressed as a fraction of the standard deviation for the week; and an expected abundance for the current week that is the mean of the prior years adjusted up or downward based on the recent abundance pattern in the area is calculated.

In various implementations, the list of biological objects can be refined, adapted and/or updated in real-time based upon the species recorded by the user. For example, if the user records observing “Black-throated Sparrow”, “Verdin” and “Black-tailed Gnatcatcher”, then the list of biological objects can be refined to include those species, such as, for example, “Ladder-backed Woodpecker”, “Costa's Hummingbird”, “Abert's Towhee” and “Northern Cardinal” that are commonly observed along with the recorded species. In other words, the list of biological objects can include those species of biological objects that have a high spatial or temporal correlation with sightings of other species of biological objects. This can be advantageous in generating a list of biological objects that are likely to be observed in the absence of any geographical location information. The list of biological objects observed by the user could be used to deduce the location, habitat, date, or time of the observation and to retrieve a likely list of species that can be observed at that location and time. For example, if the user reports “Western Gull”, “Sabine's Gull”, “Black Storm-Petrel” and “Sooty Shearwater”, it can be deduced with a high degree of accuracy that the sighting is off the coast of California in September. The list of biological objects could then include birds such as “Ashy Storm-Petrel” and “Pink-footed Shearwater” as biological objects that are likely to be sighted at that location and time. In various implementations, the list of biological objects can be adapted and updated in real-time based upon user inputs such as size, color, behavior of the biological object or information such as location, time or habitat.

The processor is further configured to accept the user's selection of the biological object from the displayed list of biological objects and provide some additional information associated with the biological object. The additional information can include movement information, counts, estimated numbers, percentages of total individuals present, percentages of ground cover, subjective scales of abundance/rarity; subjective scales of detectability, or information regarding the observed characteristics or behavior of the biological object. If the information provided by the user is outside a certain range, for example, if it is greater than an expected threshold value and/or is below a threshold value, as shown in block 226, then the processor can be configured to request confirmation as shown in block 228. In various implementations, the threshold value can be equal to a maximum estimated value. In some implementations, the threshold value can be equal to a minimum estimated value. Confirmation may be performed via keystrokes, button push, drop-down menu, verbally or by any other suitable method. Confirmation may be performed in real-time or after the fact. Confirmation may be performed by the observer; by the observer and then confirmed by one or more additional quality checks by one or more designated users; by a different user; by a pattern recognition system or not at all. In some implementations, the confirmation request can be made in real-time by the processor or at a later time by remote systems. In another embodiment, the confirmation can be requested of the same user or one or more different users in the vicinity of the geographical location can be asked to confirm the count associated with the biological object. The range within which confirmation is not requested can be determined by the estimated likelihood of occurrence and/or the abundance of the biological object at the geographic location at that time. In various implementations, the range within which confirmation is not requested may be based on a previously calculated accuracy of observer sightings; a subjective setting determined by an authoritative entity such as a moderator, leader or manager; user settings and/or by other appropriate methods. The range within which confirmation is not requested can be further updated and re-calculated in real-time based on the data provided by the user, such as, for example, by recalculating the expected abundances or likelihoods of species based upon correlations with abundances of other species already reported. For example, if the user has reported numerous species associated with an open water habitat in eastern North America in late Spring such as multiple species of ducks and grebes found in that habitat and geographical region, then the range within which confirmation is not requested for other water-dependent species might be relaxed by an adaptive algorithm in real-time and the range within which confirmation is not requested for desert species might be tightened to reflect expected levels for those species in a water habitat in eastern North America in late spring. Similarly the range within which confirmation is not requested might be adapted in real-time as more accurate estimates of location, altitude, habitat, user skill and ecosystem composition become available.

The processor is further configured to generate an electronic record including at least one of: location provided by the user, current location determined by a GPS included in the device or a default location preset by the user; date/time provided by the user, current date/time provided by the device or obtained from a remote location (e.g. www.time.gov or NIST or USNO, etc), the biological object information, count associated with the biological object information about the effort expended to search for biological objects, such as the number of observers, time, distance, area covered or other measures of effort. The processor is configured to transmit the generated electronic record to a remote network location to update a database, or be transmitted to another computer via a programming interface, or to be sent to one or more users at different geographic locations via email or instant message, or to be shared/broadcasted as a twitter message, Facebook update, blog entry, etc. as discussed above. In various implementations, a visible, UV or IR image of the biological object, a voice recording of the biological object, information associated with movement of the biological object can be transmitted along with the generated electronic record. In various implementations, the processor can transmit the generated electronic record in response to an input from the user. The generated electronic record can be stored in the internal storage device of the system 100 until the generated electronic record is transmitted or deleted by the user. In some implementations, the processor can be configured to automatically transmit the generated electronic record automatically after a certain time interval specified by the user or after a certain number of electronic records are generated. In various implementations, a number of the generated electronic records can be transmitted together as a batch. In various implementations, the system 100 can operate only when a connection to the internet, mobile network, cellular network or other network is available. In various implementations, the system 100 can be configured to operate in the absence of a connection to the internet, mobile network, cellular network or other network, and then to communicate the generated electronic record automatically or in response to a user command when a network connection becomes available.

In various implementations, a photograph, video, voice recording, verbal notes, image of a drawing or handwritten notes, etc. of the biological object sighted or observed can also be transmitted to the remote location. In various implementations, the electronic record may be shared as an individual record in real-time. For example, if the sighting or observation of the biological object is rare, then the electronic record may be activated by the user and/or automatically so as to be shared in sufficiently real-time (e.g. within 10 seconds, 20 seconds, 30 seconds, etc.). Alternately, the generated electronic record can be stored in the information stores of the system 100 and shared alone or along with other generated electronic records (e.g. 2, 5, 10, 20, 50 or 100) as a batch process at a later time. In various implementations, the processor may generate an electronic form pre-populated with geographical location information, date/time, biological objects that will most likely be observed or sighted, etc. to display to the user. The user can then provide the count information for the biological objects sighted or observed to be entered into the form. The processor can transmit the form to a remote location for sharing with other users, for further processing or for any other purpose.

In various implementations associated with organized group surveys such as Christmas Bird Counts, America's Birdiest County, The Big Sit, Project Feederwatch, etc, additional information may be associated with the record, such as, for example, the name of the assigned count area(s); observer type (e.g. Feeder watcher, owler, regular), Field conditions (e.g. general description, min and max temp, wind speed and direction, percentage of cloud cover, percentage of open water, snow cover, etc.), start time, stop time; number of observers; number of parties; party hours by car; party distance by car; party hours by foot; party distance by foot; the name or code of the Christmas Bird Count; names and contact information of the observers; distance traveled by foot, car, boat or other means of transportation; duration of observation; and payment information. In various implementations associated with organized group surveys such as Christmas Bird Counts, America's Birdiest County, The Big Sit, Project Feederwatch, etc., additional information may be associated with the record, such as documentation of rare or unusual observations,

The user can use the system 100 to let other users, other groups and/or people know of and/or databases with a sighting of a biological object. With a view to aiding others to observe the biological object, the user can choose to share his/her exact geographic location. For example, by sharing sightings of interest, others who may be interested in observing the biological object may be able to travel to the geographic location and observe it. The observation could also be listed in a record of any type, support a count, posted on a tally sheet of any sort or otherwise stored. The sighting could also be posted so as to become a permanent record such as a life list, or any other long-term recording. The observation could be shared for the purpose of seeking the opinions of other users or pattern recognition resources with regard to the identification of the biological object. For example, the observation could be shared in order to definitively and permanently document the occurrence of a rare species in an unexpected location and/or time. As another example, the observation could be shared as part of a competitive social game in which multiple users attempt to document as many species as possible in a given area within a year, and the sharing serves as a way for them to mutually confirm and quality check the results of the other contestants. As yet another example, the observation could be shared as part of a social game in which users try to provide as many challenging, interesting and/or unique photos, videos or sound recordings as possible, and their efforts are scored by other users viewing their submissions.

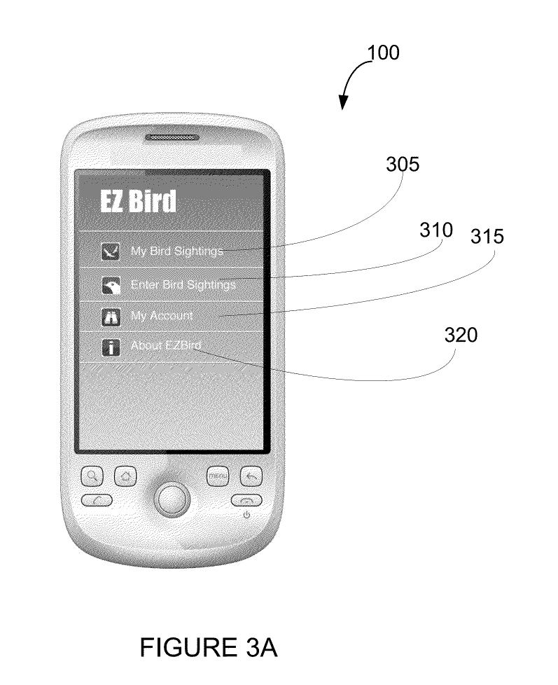

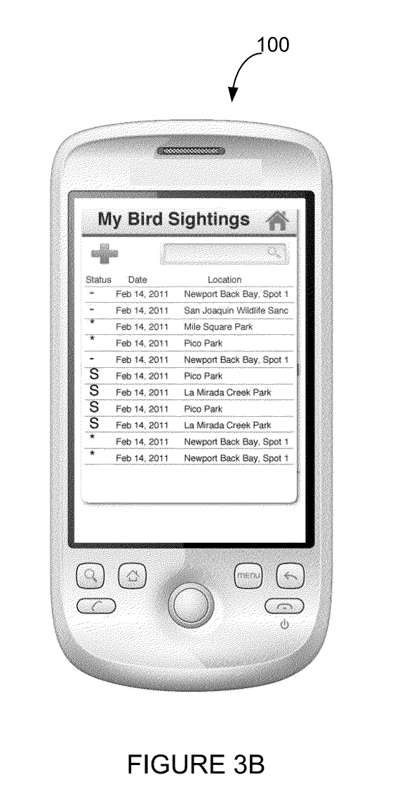

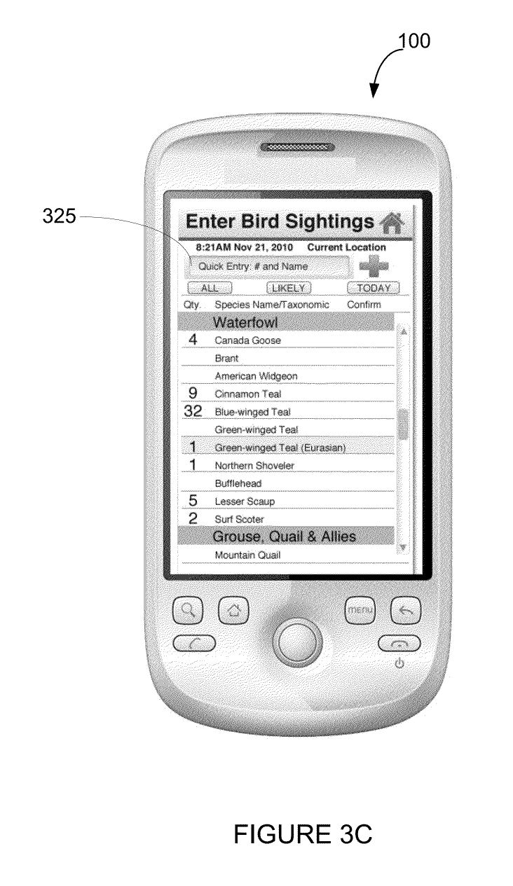

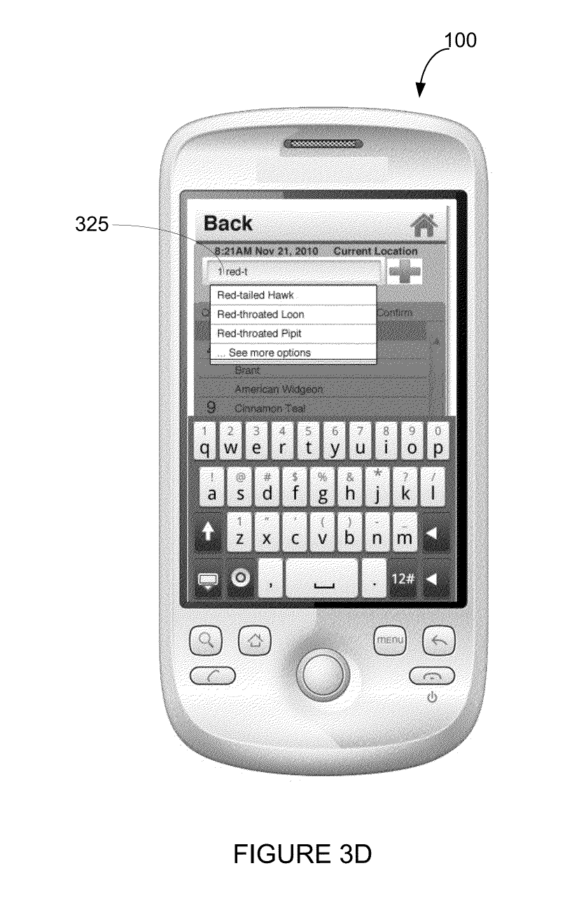

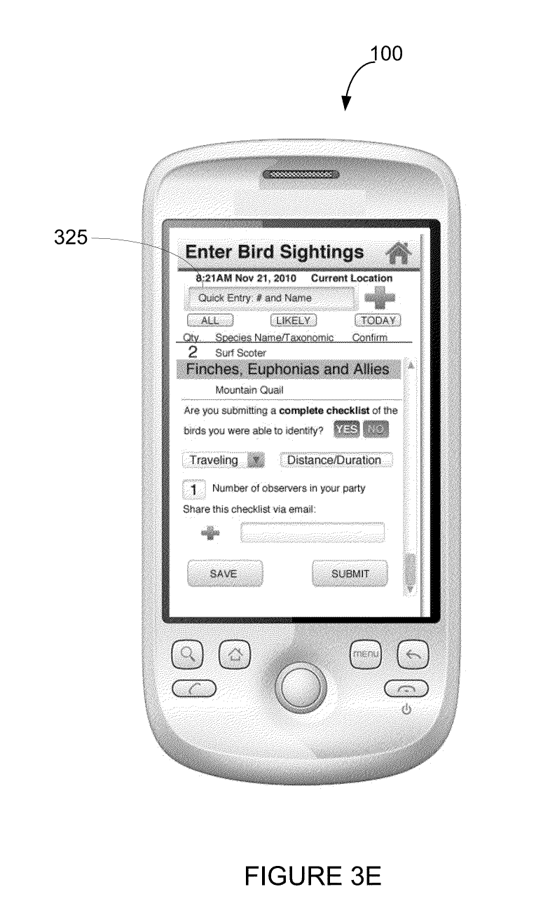

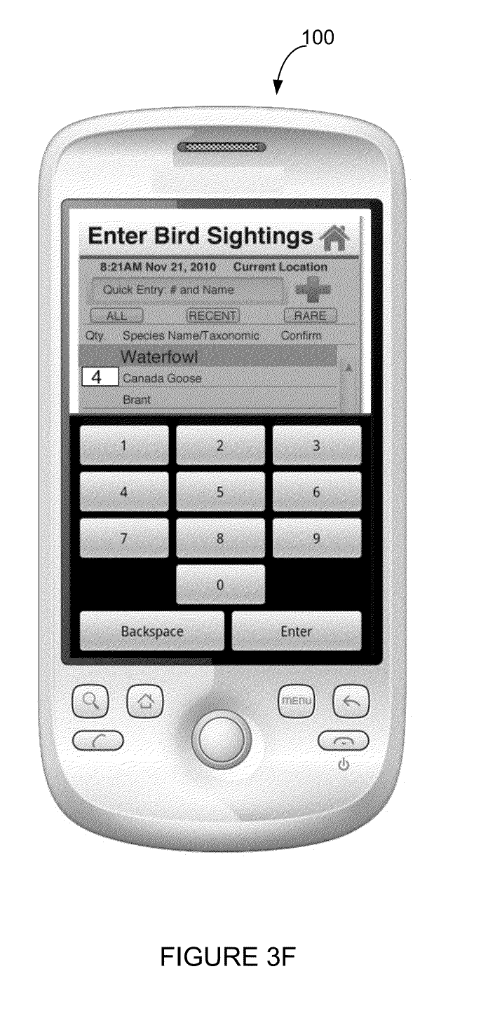

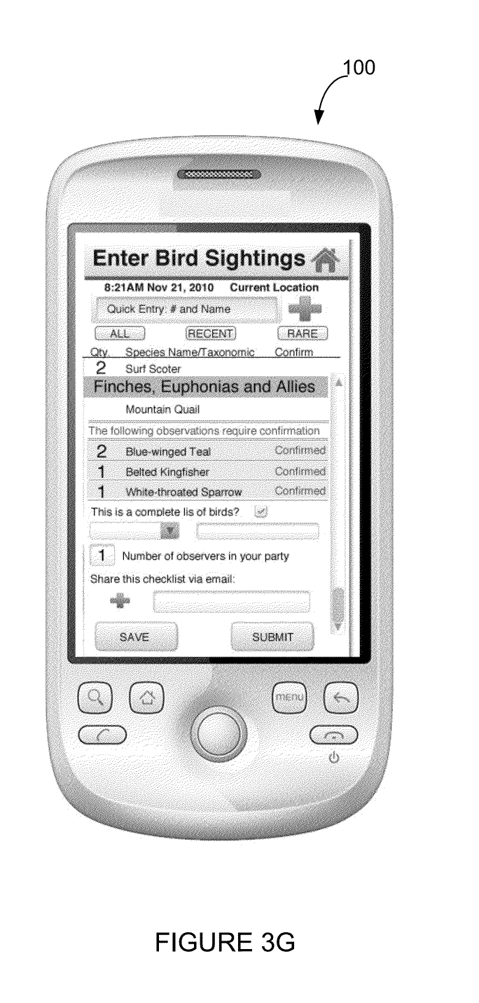

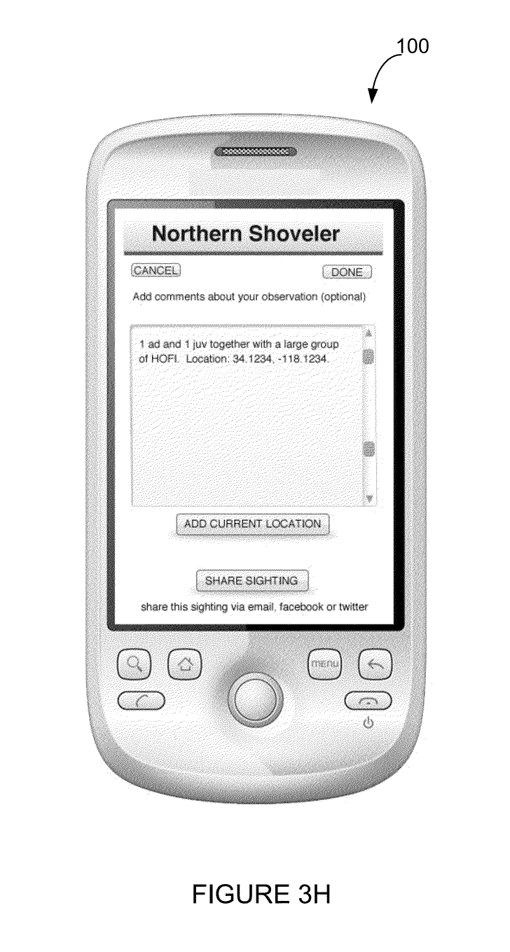

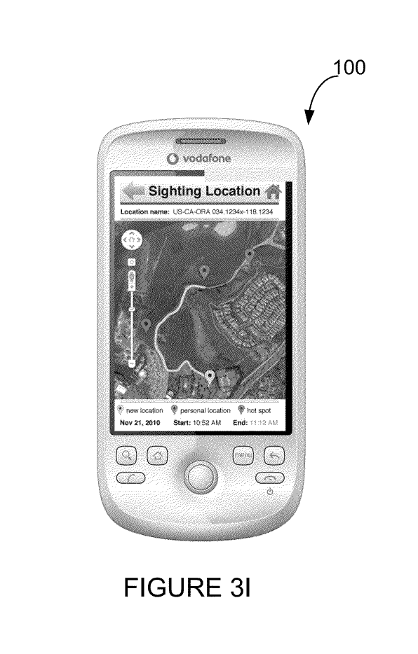

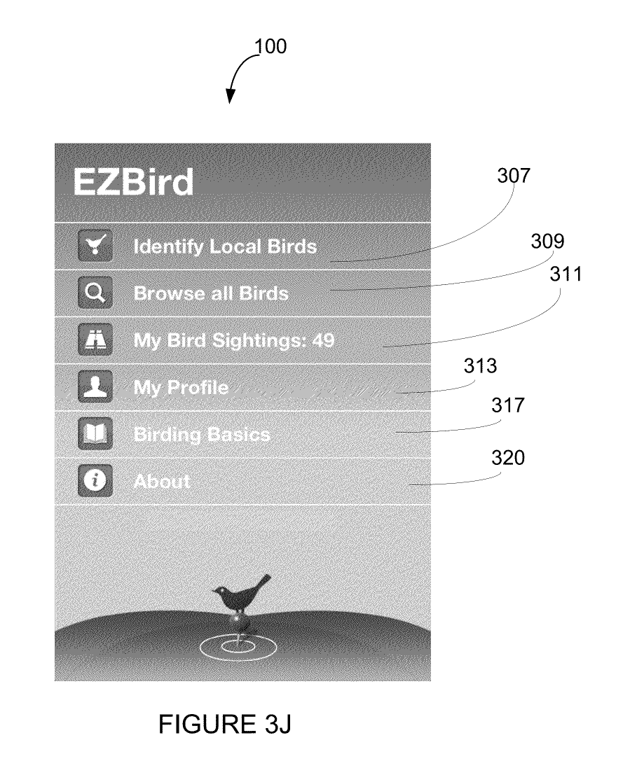

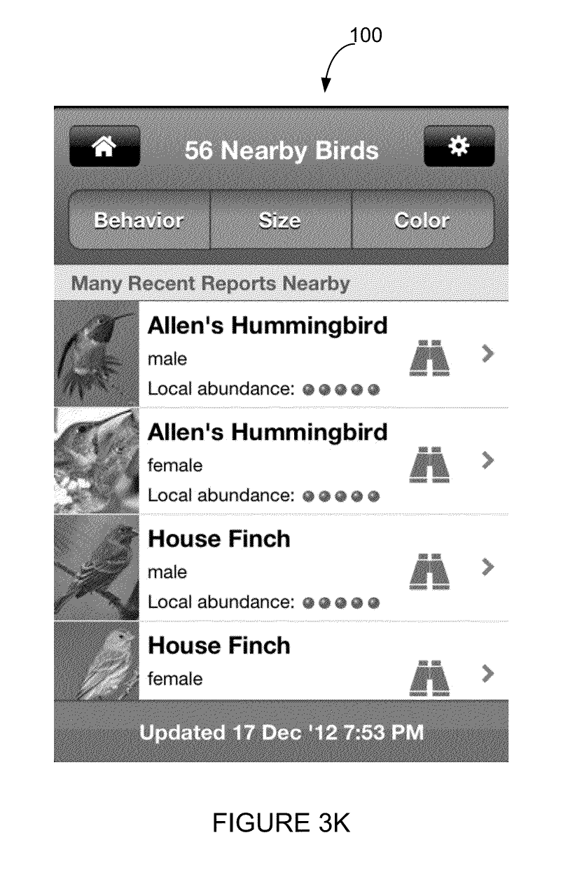

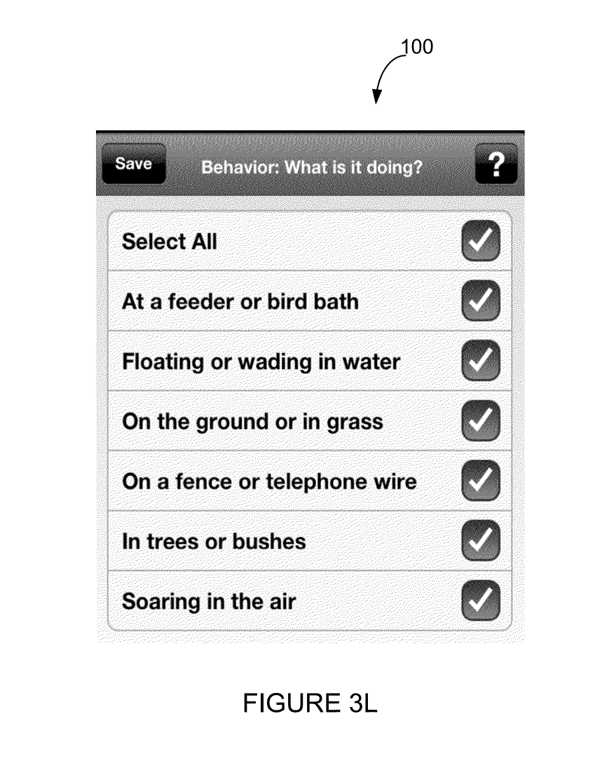

FIGS. 3A-3L illustrate an implementation of a system 100 configured to perform some of the operations performed by the method illustrated in FIGS. 2A and 2B. In FIG. 3A1, a welcome screen is displayed by the system 100 (e.g. a smart phone, a mobile computing device, etc.) when the user accesses or enters the biological object location and identification application. The welcome screen can include one or more menu items through which the user can access different modes of operation of the application and perform different functions. For example, by accessing menu item 305 titled “My Bird Sightings,” the user can obtain a list of biological objects (e.g. birds) sighted or observed by the user on a certain date and at a certain geographical location, as illustrated in FIG. 3B. In various implementations, by accessing menu item 305 titled “My Bird Sightings,” the user can obtain a list of all the biological objects (e.g. birds) sighted or observed by the user in the past few days or months.

As another example, accessing menu item 310 titled “Enter Bird Sightings,” displays a screen, as shown in FIG. 3C, through which the user can input information about recent sightings and observations. The user can maintain his/her account, change his/her profile and other personal information, change his/her preferences by accessing menu item 315 titled “My Account.” The user can obtain additional information about the application by accessing menu item 320 titled “About EZ Bird.”

FIGS. 3C-3F show screen shots of different implementations entering information about the biological object sighted or observed. The screen displayed in FIG. 3C represents a list that the user can use to enter the information associated with sightings or observations of biological objects. The displayed screen includes information about the geographical location and the time and date of the observation or sighting. The geographical location and the time and date can be obtained by the processor in the system 100 or provided by the user. The displayed screen includes an area 325 into which the user can enter the name and the number of the biological object sighted or observed.

In various implementations, a list of various biological objects can be displayed to the user. The displayed list can be a list of all the biological objects in a catalogue (e.g. all the birds from the eBird database), or a list of the likely biological objects (e.g. birds from a catalogue) that can be observed or sighted at that geographical location, or a list of the likely biological objects (e.g. birds) that can be observed or sighted at that geographical location at that time of the day and year. In various implementations, the displayed list can be a dynamic list that is generated using recent data of biological object sightings by other users. The dynamic list can be updated in real-time by communicating with a remote server that receives information about biological object sightings and observation for multiple users and stores them in one or more databases that can be accessed by the processor of the system 100. In some implementations, the displayed list can be a default check list of all birds available in an area. The default list can be stored locally in the system 100 and can be used when network connection is unavailable. The displayed list of the biological objects can be arranged in alphabetical order or in the order of the likelihood of occurrence or in the order of the number of recent sightings. In various implementations, the biological objects in the displayed list can be grouped into different categories such as “Waterfowls,” “Grouse, Quail and Allies,” etc. In various implementations, the categories can be based on scientific principles, such as, for example, species and sub-species. In some implementations, the categories can be based on colloquial terms that are referred to a group of biological objects. In various implementations, the displayed list can be expanded or collapsed based on the category title.

In various implementations, the user can input information associated with the biological object sighted or observed by clicking or tapping on the name of the biological object from the list and entering a number indicating a count for the biological object. In various implementations, the count can be entered into a region or field that is displayed in response to the user clicking or tapping on the name of the biological object from the list as shown in FIG. 3F.

In various implementations, the user can enter a count and the name of the biological object in the area 325 so that the user can quickly and efficiently enter information associated with the biological object without having to navigate through the displayed list. Accessing the area 325 (e.g. by tapping the field) can bring up a number pad. The user can enter the number of the biological objects (e.g. birds) sighted. After entering the number or count associated with the biological object, the user can enter a character such as “a space bar” or “a period,” or “a comma”, etc. In response to the user's entry of the character the number pad can be replaced by a text keyboard. As the user begins to key in the name of the biological object a drop-down list can be displayed that displays possible names of biological objects that match the letters keyed in by the user. The names can be common names for the biological object, scientific names for the biological object or codes or abbreviations for the biological object. The possible names of biological objects displayed in the drop-down list can be arranged in alphabetical order or in the order of the likelihood of occurrence. The possible names of biological objects displayed in the drop-down list can be a portion of the list of biological objects generated or received by the processor. If the user spots the name of the biological object he/she wishes to enter, the user can select the name without having to input the entire name. This can be advantageous in increasing the speed and efficiency with which information is entered.

In various implementations, the processor can request confirmation for certain sightings, as shown in FIG. 3G. The information entered by the user with or without confirmation can be stored as an electronic record in the system 100. The user can be provided with the option of entering additional information or notes as shown in FIG. 3H. The additional information or notes can include information regarding behavior, physical movement of the biological object, color of the plumage, information associated with the well-being of the biological object, nesting information of the biological object, etc. In various implementations, the additional information can include an image of the biological object and its surrounding or a sound recording of the biological object.

FIG. 3J illustrates a welcome screen displayed by an alternate implementation of the system 100 to the user when the user accesses or enters the biological object location and identification application. The welcome screen can include one or more menu items through which the user can access different modes of operation of the application and perform different functions. For example, by accessing menu item 307 titled “Identify Local Birds,” the user can view a list of local birds that were recently sighted at or near the user's location as shown in FIG. 3K. The list of birds provided to the user can include an image of the bird for easier identification. In various implementations, the list can also provide the abundance for each listed bird. In various implementations, the user may be provided with the option of narrowing the list of birds based on at least one of behavior, size, color, etc. as shown in FIG. 3K. In various implementations, the behavior of the listed bird can include information about what the bird is doing as shown in FIG. 3L. For example, the bird could be at a feeder or in a bird bath, the bird could be floating or wading in water, the bird could be on the ground or in grass, the bird could be on a fence or telephone wire, the bird could be in a tree or a bush, or the bird could be flying in the air. In various implementations, the behavior of the bird could be noted along with the count and other information when information about the bird sighting is recorded as discussed above.

In FIG. 3J, the user could browse a list of all birds by accessing menu item 309 titled “Browse all Birds,” to identify a bird that he/she has sighted. The user could maintain a record of the birds he/she has recently sighted by accessing menu item 311 titled “My Bird Sightings.” The user could learn about birding by accessing the menu item 317 titled “Birding Basics.” The user could change or edit his/her profile by accessing menu item 313 titled “My Profile.”

In various implementations, the user can use the application to select locations that have an abundance of biological objects that the user may be interested in watching or sighting. For example, the user can use the application to locate bird sanctuaries, nature parks, nature preserves, etc. that are nearby to the user's present location. The user can select the location he/she wants to visit. In various implementations, the application can display a map that provides directions to the user to the selected location from the user's present location.

### Use of Shared Information by Other Users

Information shared by a user via the system 100 may be intended to be used by others. The system 100 is designed to permit the user to access, view, manipulate and use information from other users. The processor may be adapted to permit the user to perform one or more of the following actions: define criteria for what types of shared information from other users the user wishes to view; define how the user wishes to view or receive the shared information; define one or more criteria for the system to notify the user when those criteria are met by new shared information; to define how the system is to notify the user when different types of shared information are received. In one implementations, and using birds as an example, the user may specify that they wish to receive a daily email summarizing sightings of birds reported by users that meet certain criteria, such as, for example: the bird was reported within 25 miles of the user's location, and the species observed is not on the user's life list, year list or list for a designated location such as the state of California. As another example, a researcher may wish to be notified via immediate text message each time a very rare or endangered species is reported anywhere or within a certain distance from the user's location. In another example, the user may specify that they wish to receive a daily report of how many birds have been reported in a specified area and timeframe, such as Los Angeles County during the current calendar year. In another example, the user may specify that they wish to receive a daily report of how many birds the user has reported in a specified area and timeframe relative to other users, such as a ranking of the top birders in North America during the current calendar year. In another example, the user may specify that they wish to receive a daily report showing how or how many other users have liked, commented on, used, rated, identified or otherwise interacted with their shared sightings. Other uses of the information that evolve to satisfy user interests, for marketing purposes, for broader information sharing and any other purpose are also contemplated.

In various implementations, groups of users may choose to share selected information with other participants, an organizer, a moderator, a sponsor organization, their employer or other participants, as part of organized surveys or competitions, such as for Christmas Bird Counts, America's Birdiest County, Project Feederwatch, the Big Sit, Big Year competitions, or local ad-hoc or special purpose surveys. In various implementations, groups of users may choose to view shared information from other participants or the public, as part of organized surveys, such as for Christmas Bird Counts, America's Birdiest County, Project Feederwatch, the Big Sit, Big Year competitions, or local ad-hoc or special purpose surveys. In various implementations, these groups of users may be organized or moderated by one or more people. In various implementations, users may wish to share information in order to see real-time totals or lists of objects detected; to see real-time information about which target species have not been found; to see real-time information about which areas have been surveyed; to see real-time information about which areas still need to be surveyed; or to see summary statistics such as total number of species detected, total observers, total miles driven, walked or boated, to sites visited, etc. In various implementations, users may wish to see comparisons of how their group is performing by various measures, such as total number of species detected, total number of observers, total miles driven, walked or boated, to sites visited, etc. In various implementations, users may wish to see comparisons of how their group is performing by various measures, such as total number of species detected, total number of observers, total miles driven, walked or boated, to sites visited, etc. compared to plan, or compared to the performance of their group in previous surveys, other groups, averages of other groups, other groups within a specified area, other groups that meet specific criteria.

### Biological Object Location and Identification

The system 100 can also be used to locate and identify biological objects sighted or observed in addition to or instead of sharing information associated with them. For example, if the user observes or hears a biological object, he/she can use the system 100 to capture an image/movie, voice record of the biological, infrared picture, ultraviolet movie of the object or capture any other useful record of the biological object that aids in identification of the object. In various implementations, the system 100 can be configured to automatically capture such information. The system 100 can then be used to identify the object based on the image/movie, voice record of the biological, infrared picture, ultraviolet movie of the object or capture any other useful record of the biological object that aids in identification of the object to identify the biological object by searching databases, catalogues and/or any other information stores of the system 100 or by transmitting the captured image/movie, voice record of the biological, infrared picture, ultraviolet movie of the object or capture any other useful record of the biological object that aids in identification of the object to one or more remote systems, or any other external resource that aids in identification. The electronic hardware processors included in the system 100 or the remote system can use image recognition, voice recognition technology, spectral content, temperature profile, or any other captured characteristic, and/or changes over time in these variables to identify the biological object.

In various implementations, the user can transmit the captured image/movie, voice record of the biological, infrared picture, ultraviolet movie of the object or capture any other useful record of the biological object that aids in identification of the object. The captured image/movie, voice record of the biological object, infrared picture, ultraviolet movie of the biological object or any other characteristic of the biological object that aids in identification of the biological object can be shared with other users, user groups, experts, expert groups or any other knowledgeable entity who may be able to provide identification of the biological object and/or further information regarding the biological object. In some implementations, user's geographical location, altitude, weather condition, date, time and/or other captured information can also be transmitted along with the image/movie, voice record of the biological object, infrared picture, ultraviolet movie of the object or capture any other useful record of the biological object that aids in identification of the object to help in the identification process.

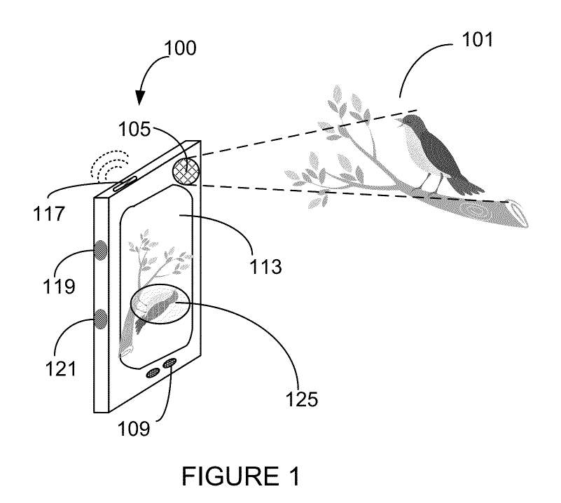

The system 100 of FIG. 1 can be used to locate and identify biological objects from the surrounding area based on image, voice signature or both. For example, the physical computer processor of the system 100 can be configured to process the incoming sound data received from the one or more sound transducers 119 to detect sounds from the surrounding area that are produced by biological objects of interest. In various implementations, the system 100 can use noise cancellation methods and systems to isolate sounds originating from biological objects from background noise, sounds from passing cars and planes, or other human voices. In various implementations, the processor is configured to estimate the direction from which the sound originates to aid in locating the biological object. In various implementations, the direction can be estimated relative to the system 100. In other implementations, the estimated direction can include the latitude, longitude and altitude information of the estimated origin of the sound. The processor can use known signal processing algorithms and methods and other sound localization methods to estimate the direction of the detected sound. In various implementations, time of flight methods, or methods based on the Doppler effect can be used to estimate the direction of origin of the detected sound. In some implementations, radar or sonar methods can be used to estimate the direction and the location of the biological object producing the detected sound. In various implementations, the one or more sound transducers 119 can include a directional microphone to aid in sound detection and localization.

The estimated direction can be within a margin of error from the actual direction. In various implementations, the system 100 can calculate the error in the estimated direction based upon the nature of the received sound and the configuration of the one or more sound transducers 119 or other factors. In various implementations, the size of the visual indication can be based on the calculated error. For example, if the calculated error is large then the area of the visual indication is large. However, if the calculated error is small then the area of the visual indication is small. When the estimated direction is outside of the area depicted visually on the display, the system can display a special indicator on the border of the image to indicate that a sound occurred outside of the area of view. This visual indication can give a rough indication of the direction of the sound. Alternatively, the visual indications for sounds outside of the field of view can be omitted.

The processor can generate an electronic record of the detected sounds from biological objects along with the estimated direction and the time of detection. Each record can be stored as a sound event in the system. Without subscribing to any particular theory, a sound event defined as a sound having a unique aural characteristic (e.g. unique pitch, unique frequency content, or a unique tone) that originates from a certain direction at a certain time. In various implementations, the different sound events detected by the system 100 can be displayed to the user as a visual indication 125 coinciding with the estimated direction and superimposed on a view of the surrounding area displayed to the user on the display 113. The visual indication can include at least one of a shape, a symbol, a shaded area, a colored region, and a region of increased brightness. In various implementations, sounds having a same unique aural characteristic can be represented by the same visual indication. For example, sounds originating from crows can be visually indicated by a red circle. As another example, a dog bark can be visually indicated by a blue square. In various implementations, the visual indication 125 can persist for an interval of time after the occurrence of the sound event. For example, in various implementations, the visual indication can persist for about 1-10 minutes after its occurrence. In various implementations, the brightness of the visual indication 125 can gradually decrease over time during the persistence interval. For example, during the persistence interval, the visual indication 125 can appear to fade with time. In various implementations, the visual indication can move as the orientation of the displayed view changes such that the absolute direction of origin of the sound event remains the same.

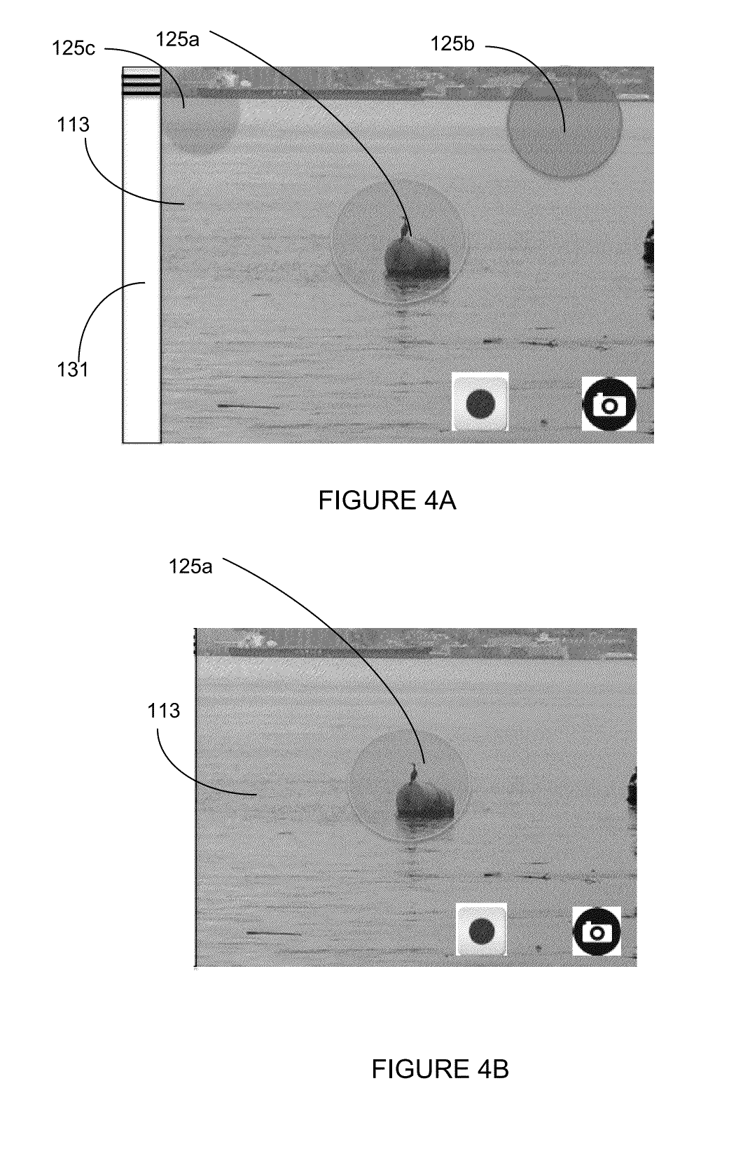

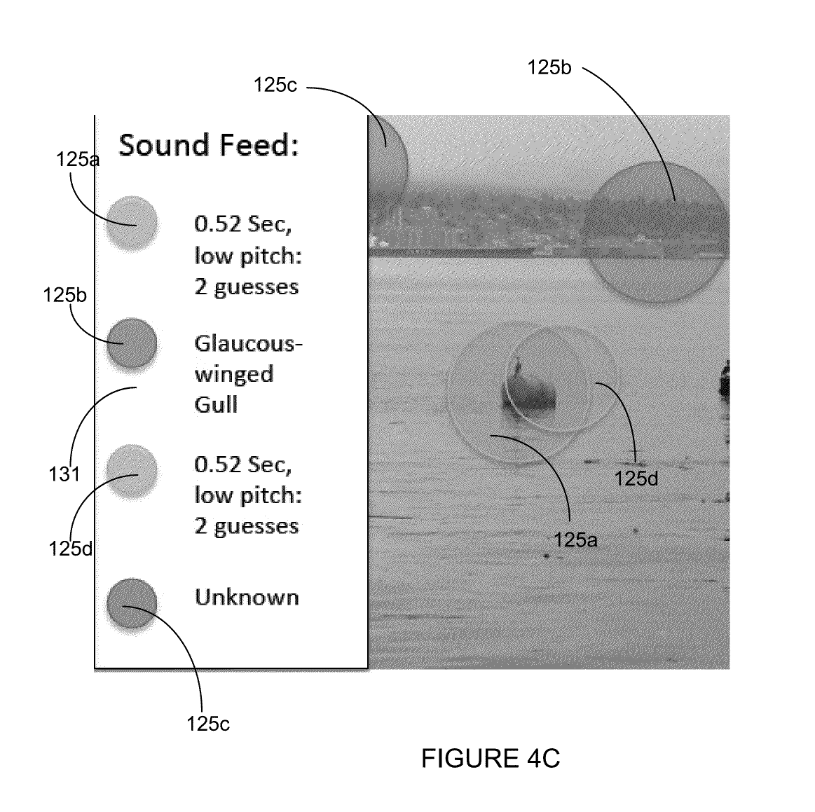

As discussed above, in various implementations, the processor can be configured to analyze the received sound and recognize different sound patterns and frequencies such that sounds from different biological objects of interest originating from the same geographical location at approximately the same time are stored as different sound events. In such implementations, different visual indications can be simultaneously superimposed on the displayed view coinciding with the direction of origin indicating different sound events. The processor can be configured to detect sound events in sufficiently real-time. For example, in various implementations, the sound events can be detected and displayed as a visual indication within about 1-30 seconds of its occurrence. In various implementations, the processor can be configured to detect the change in the direction of the origin of the sound event and update the visual indication 125 accordingly. Such implementations can advantageously indicate the movement of the biological object visually on the displayed view. These and other aspects are discussed in detail with reference to FIGS. 4A-4C below.

FIGS. 4A-4C are implementations of the system 100 showing visual indications representing sound events superimposed on displayed view of the surrounding. The user can access the application controlled by the system 100 that is configured to locate and identify biological objects in the surrounding area. Upon accessing the application, the processor in the system 100 can display a view of the surrounding area on the display device 113. The displayed view can be obtained in part by the optical imaging system 105. The processor can automatically or upon receiving a command from the user detect one or more sound events in the surrounding area and superimpose them on the displayed view as visual indications 125a-125d as discussed above. In various implementations, a sidebar 131 can be provided to access various menus of the application and perform different functions.

In various implementations, identity of the biological object that produces the sound event can be identified by comparing the aural characteristic of the received sound with aural characteristics of known biological objects. The identity of the biological object that produces the sound event can be restricted to those biological objects whose aural characteristics closely match the aural characteristics of the received sound. The identity of the biological object that produces the sound event can be further restricted to those biological objects whose aural characteristics closely match the aural characteristics of the received sound and those biological objects that have a higher likelihood of occurrence at that geographical location at that time of day and year.

In various implementations, the comparison between the aural characteristic of the received sound with aural characteristics of known biological objects can be performed locally in the system 100 by the processor. In some implementations, the aural characteristic of the received sound and other information such as geographical location, time of the day and the year can be transmitted by the processor to an external source and the comparison may be performed remotely at the location of the external source. The results of the comparison may be transmitted by the external source and stored locally in the system 100.

In various implementations, the user can view a list of the biological objects whose aural characteristics closely match the aural characteristic of the received sound by accessing the visual indications 125a-125d. Additional details of the sound event can also be obtained by accessing the visual indications 125a-125d. In various implementations, the user can record the aural characteristic of different sound events by accessing the visual indications 125a-125d corresponding to the different sound events. In various implementations, the user can zoom into the region of the view within the visual indication to obtain a better view of the biological object producing the sound event.

In various implementations, the system 100 can be configured to detect and identify sounds coming from a particular direction. In such implementations, the sounds detected from other directions can be attenuated by 10-30 dB as compared to the sounds detected from the direction of interest. In such implementations, the visual indication is superimposed only on the direction of interest. For example, in the implementation illustrated in FIG. 4B, only sounds detected from the region represented by the visual indication 125a is detected.

FIG. 4C illustrates the expanded view of the sidebar 131 which provides information regarding the various sound events 125a-125d. In FIG. 4C, sound events 125a and 125d had similar aural characteristics and are thus represented by the same visual indication (e.g. yellow circle). With reference to FIG. 4C, the identity of the biological object producing the sound event 125c could not be determined; while the identity of the biological object producing the sound events 125a and 125d was narrowed down to two possible biological objects; and the biological object producing the sound event 125b was positively identified. In various implementations, the number of visual indications displayed might be intentionally limited to accommodate the space available on the screen or the list. Similarly, the number of visual indications might be limited to just those that match specific options selected by the user, such as those that match the characteristics of a target species or group.

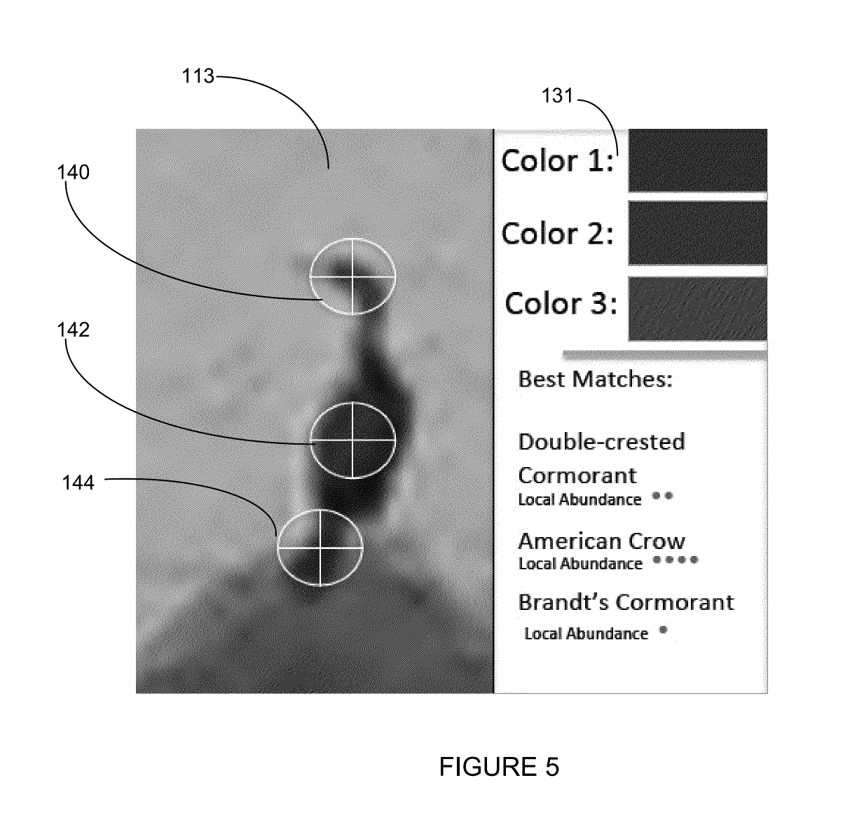

As discussed above, the system 100 of FIG. 1 can be used to locate and identify biological objects from the surrounding area based on image, voice signature or both. For example, the physical computer processor of the system 100 can be configured to process the incoming image information from the surrounding area to locate and identify biological objects. FIG. 5 illustrates an implementation of the system 100 in which portions of the incoming image information from the surrounding area are analyzed to locate and identify biological objects. The user can access the application controlled by the system 100 that is configured to locate and identify biological objects in the surrounding area. Upon accessing the application, the processor in the system 100 can display an image of a biological object or a view of the surrounding area on the display device 113. Using image processing methods, the processor can display portions of the surrounding view where biological objects of interest may be present. For example, if the surrounding view includes a lake surrounded by buildings then only the portion of the view around the lake is displayed since the likelihood of occurrence of biological objects around the lake is higher as compared to the likelihood of occurrence of biological objects around the buildings. Alternately, the user can select portions of the displayed view depending on the presence of biological objects of interest. In some implementations, the system 100 either automatically or in response to a command from the user can zoom to bring one or more biological objects into view. To identify the biological object, the user can select a subset of the biological objects in view or at least a portion of the displayed image for further analysis and identification. For example, the user can tap one or more points on the image and the system 100 can use the one or more points selected or an area around those one or more points for further analysis. As another example, the user can swipe a portion of the image to indicate one or more lines and the system 100 can use all of the points along the one or more lines indicated by the user or an area around the line for further analysis. As another example, the user can outline one or more areas of the image and the system 100 can use all of the points inside the outline of those one or more areas for further analysis. As yet another example, the user can tap on a portion of the image and the system can use all of the points that have a color approximately similar to the color in the portion selected by the user for further analysis. The user can select a list of visual indications such as shape, form, size, color of the plumage, etc. that can be matched to identify the biological object. Depending on the user's selection various visual characteristics of the selected biological objects can be obtained by using image processing methods. For example, by image processing methods, the color of the plumage of the selected biological objects, the size of the head of the selected biological objects, the size and shape of the neck of the selected biological objects and other visual characteristics can be obtained or extracted. The obtained visual characteristics can be compared with visual characteristics of known biological objects to narrow the identity of the selected biological objects. For example, if the plumage of the selected biological object is black then the identity of the selected biological object can be narrowed to only those biological objects having black plumage. In various implementations, the comparison can be performed locally at the system 100. In other implementations, the comparison can be performed remotely and the results of the comparison can be transmitted to the system 100. In various implementations, the comparison can be performed by comparing the obtained visual characteristics with visual characteristics of different biological objects saved in a visual characteristic reference database. The visual characteristic reference database can be located locally at the system 100 or remotely.

In various implementations, the user can select different portions of the image corresponding head, the body or the tail of the bird for analysis and identification. For example in FIG. 5, the user can select one of the regions 140, 142 and 144 of the biological object in view for further analysis and identification. As shown in FIG. 5, based on the color information obtained or extracted from the regions 140, 142 and 144 of the biological object in view, the possible list of biological objects that closely match the biological object in view are “Double-Crested Cormorant,” “American Crow,” and “Brandt's Cormorant.” The local abundance of each of these species is also provided to aid in identification process. Other characteristics such as the shape of the neck or the size or the sound characteristic can be further analyzed to restrict the list of possible matches even further.

An implementation of a method to identify the biological object based on an image, movie, voice record of the biological, infrared picture, ultraviolet movie of the object or capture of any other useful record of the biological object as part of the current system, would be through a social online system in which two sets of users participate and interact: the first group are those who submit image, movie, voice record of the biological, infrared picture, ultraviolet movie of the object or capture any other useful record of the biological object; and the second group are those who identify the biological objects in the image, movie, voice record of the biological, infrared picture, ultraviolet movie of the object or capture any other useful record of the biological object.

This system has characteristics of a game for the users. Users could participate both as submitters and/or reviewers. The first group of users could range from very casual participants who submit one file for identification on a single occasion to active photographers or other participants who submit many files daily. The submitting users could compete in various dimensions, including number of files submitted; number of files judged to be the best in their category by reviewing users; average quality of files, as judged by reviewers; and/or the total number of species for which files have been submitted either for the entire duration for which records are available or within a specified timeframe and/or geographic area, etc. Reviewing users could compete on historical performance in terms of identification accuracy relative to other users or relative to objects whose identities are known positively; number of biological objects identified either overall or within a specified timeframe and/or geographic area; number of reviews provided; average speed of identification, etc. For the gaming aspect, it may be advantageous to provide an incentive system that produces rapid, accurate results. For example, users could earn points for participation that could be redeemed within the game for various types of rewards, access to new levels or locations, etc. For rapid and accurate identification, an adaptive scoring system that directs files to the users most likely to accurately identify a biological object in a category is included in the system. The adaptive scoring system can include an adaptive, real-time file routing system. Routing of a file to a specified user would be based on one or more of the following: estimated difficulty of the file as judged by identification correlations of reviewers and identification times, estimated skills of the reviewers relative to the estimated difficulty of identifying the file, the location and date/time of the file relative to the estimated skill level of various users at identifying files at that location and/or date/time. The system can also include a scoring algorithm that picks the answer with the highest probability of being correct from among the answers provided by various users. For example, the algorithm could be updated each time a “guess” is received from a user, based upon the number of reviewers who have provided each answer, weighted by a ranking of the skill levels of the reviewers. When the algorithm has sufficient information to identify the object with a sufficiently high degree of accuracy, the result can be sent or displayed to the submitter or otherwise broadcast to target entities. This system provides an identification of the biological object with a high probability of being correct quickly if the number of users is sufficiently large, users are sufficiently knowledgeable or mechanized identification tools are sufficiently accurate. In practice, the system could provide real-time response in a matter of minutes, hours or days.

As discussed above, the system 100 may be a implemented as a part of a smart phone, a tablet PC, desktop computer, etc. However, in some implementations, the system 100 may be a specialized piece of equipment which, for example, can be made available for purposes of short-term use such as through rental, loan or be provided at a site location, as well as by all other methods of conveyance. For example, system 100 with specific information covering local or regional conditions, could be made available for a fee at a ranger station in a game park, hunting area, national park, eco-lodge or be provided by a birding lodge for guests. The system 100 could record all local sightings real-time on a display and highlight sightings of particular interest along with a display of recent sighting locations on a map or any other form of display. Additionally, a plurality of the system 100 could be connected to each other, through a central connection (e.g. a server), or through a number of distributed connections to alert nearby users of interesting sightings quickly so other users could join the viewing.

The system 100 could also be used to train users (e.g. guides, hunters, birdwatchers, students, national park rangers, scouts, researchers, children) and/or used as a teaching aid. The system 100 could be used to develop expertise quickly in a subject area, so as to speed learning from sight, sound, size, spectral content, location, altitude and other attribute inputs. Thus, users could be knowledgeable, productive or even become expert in a very short time compared with conventional training methods for birders, ichthyologists, or any other users.

Many other uses for the system 100 enable new capabilities for birders, and any other observers of biological objects that move, change or otherwise vary. For example, system 100 that have notification capability, can be positioned to observe a location such as a watering hole, and programmed to send notification when a specific species of animal is observed, an animal of a species of a particular size (such as a baby, a particular subject, etc.) appears, a biological object that has been tagged to track its location or followed by another monitoring system come into observation range, and/or any other information gives proximity information about a biological object. The user can then be free to do other activities while monitoring a location such as part of a water hole. For observations that occur for a short time, the system 100 can be programmed to identify and record so as to capture infrequent transient events. For example, the system 100 could identify and capture the movement of migrating birds, a bird hatching, a bloom unfolding, an insect transforming from one stage to another, etc. The system 100 can also be used to track an individual within a group such as a zebra by the pattern of its stripes, a manta ray by its color pattern and the like. The system 100 can be activated to do tracking automatically, so that by positioning one or an array of systems, an individual can be tracked and its progress monitored and recorded. The system 100 can be connected to receive external signals, for example, from collars that track animals, and indicate the direction, movement, location, etc. of nearby animals of interest. For example, the system 100 could alert the user to an approaching bear and its location or the movement of nearby wolves, etc. The system 100 can also be used to locate biological objects (e.g. endangered species) and record their movements, monitor their sleeping and feeding patterns, monitor their health and well-being, etc. The information can be transmitted to other users (park rangers, wildlife organizations, etc.) that have use for the information. Thus, the system 100 can become part of an extensive network available to users that is now not available.

The system and methods described herein can also be used to help prepare travelers to prepare for their trips by allowing them to review biological objects such as the flora and fauna of the travel destinations, allow travelers to share their nature photography and/or observations of animals, birds, plants, insects, amphibians, reptiles, mammals, etc. The systems and methods described herein can also be used as an educational tool to teach children about other species of animals, birds and plants that inhabit the planet. The systems and methods described herein can be used to design fun and educational games for infants, children and adults.

Identification can be aided by using images, sound and any other method to determine the distance to a biological object by auto-focusing technologies as is presently done in auto-focusing cameras and as is known to those skilled in the art of such designs. These methods, and any other distance determining method, such as laser range finder, GPS location (e.g. if the biological object's and the user's locations are known with sufficient precision), are included in the various embodiments described herein. Distance information in combination with its relative size in an image, or any other useful attribute can be used to estimate the size of the biological object. Any other size estimation method, such as comparison with other objects (biological or not for which the size is known or can be estimated) at a known or measurable distance from the biological object, its known or estimated infrared emissions. The information can be used for help in identification of a species, determining size distribution of a population of targeted biological objects, identifying a particular member if a species, prioritizing identity options, aiding external identification resources, or for any other beneficial purpose.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain embodiments of the disclosure have been described, these embodiments have been presented by way of example only, and are not intended to limit the scope of the disclosure. No single feature or group of features is necessary for or required to be included in any particular embodiment. Reference throughout this disclosure to “various implementations,” “one implementation,” “some implementations,” “some embodiments,” “an embodiment,” or the like, means that a particular feature, structure, step, process, or characteristic described in connection with the embodiment is included in at least one embodiment. Thus, appearances of the phrases “in some embodiments,” “in an embodiment,” or the like, throughout this disclosure are not necessarily all referring to the same embodiment and may refer to one or more of the same or different embodiments. Indeed, the novel methods and systems described herein may be embodied in a variety of other forms; furthermore, various omissions, additions, substitutions, equivalents, rearrangements, and changes in the form of the embodiments described herein may be made without departing from the spirit of the inventions described herein.

For purposes of summarizing aspects of the disclosure, certain objects and advantages of particular embodiments are described in this disclosure. It is to be understood that not necessarily all such objects or advantages may be achieved in accordance with any particular implementation. Thus, for example, those skilled in the art will recognize that implementations may be provided or carried out in a manner that achieves or optimizes one advantage or group of advantages as taught herein without necessarily achieving other objects or advantages as may be taught or suggested herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A system for generating and displaying object information to enable a user to enter information associated with a biological object, the system comprising a physical computer processor configured to:
provide a list of categories of biological objects to the user;
accept user input indicating selection of at least one category of biological object from the provided list; and
process the user input to identify a biological object, wherein processing includes using past records associated with occurrence of the biological object at least one geographical location and at least one time of year.

2. The system of claim 1, wherein the list is based on at least one past record associated with the occurrence of the at least one category of biological object at the observation time or date, wherein the past record includes at least one of (i) an actual observation of the at least one category of biological object in a vicinity of the at least one geographical location of the observation time or date, or (ii) an abundance of the at least one category of biological object greater than or less than a threshold value.

3. (canceled)

4. The system of claim 1, wherein the processor is configured to accept numerical information associated with the at least one category of biological object in the numerical information including a count, a percentage, or a rating.

5. The system of claim 4, wherein the processor is configured to request additional information or confirmation if the associated numerical information is less than or greater than a threshold value, wherein the threshold value is determined by at least one of an adaptive process and a real-time process or based upon an adaptive process that uses information about the spatial or temporal correlations of the occurrence of biological objects recently reported by the user with the occurrence of other biological objects, wherein the additional information or confirmation includes at least one of: was obtained in real-time, was provided by the user, and was provided using at least one alpha-numeric character, icon or a voice command.

6. (canceled)

7. (canceled)

8. (canceled)

9. (canceled)

10. (canceled)

11. The system of claim 1, wherein the processor is configured to generate an electronic record including the user input and transmit the generated electronic record to at least one remote network element using an electronic communication system, wherein the user input includes at least one of an alpha-numeric character, an icon and a voice command, or wherein items in the list of categories of biological objects are arranged in accordance with an increasing or decreasing likelihood of occurrence, or wherein items in the list of categories of biological objects are arranged in accordance with likelihood of occurrence that is greater than or less than a threshold value, or wherein the list is generated in real-time, or wherein the list is provided to the user in real-time, or wherein the list is generated in response to at least one alpha-numeric character, icon or voice command provided by the user, or wherein the system is configured to accept user input authorizing sharing at least a portion of the information included in the electronic record with one or more different users or an electronic database.

12. (canceled)

13. (canceled)

14. (canceled)

15. (canceled)

16. (canceled)

17. (canceled)

18. A method for generating and displaying object information to enable a user to enter information associated with a biological object, the method comprising:
presenting a list of categories of biological objects to the user;
accepting user input indicating selection of at least one category of biological object from the presented list; and
processing the user input to identify a biological object, wherein processing includes using past records associated with occurrence of the biological object at least one geographical location and at least one time of year, and
wherein the method is implemented by a physical computer processor.

19. The method of claim 18, further comprising allowing the user to modify, control or limit the information presented in the list.

20. The method of claim 18, wherein the list is based on at least one past record associated with the occurrence of the at least one category of biological object at the observation time or date, wherein the past record includes at least one of (i) an actual observation of the at least one category of biological object in a vicinity of the at least one geographical location or the observation time or date, or (ii) an abundance of the at least one category of biological object greater than or less than a threshold value.

21.-58. (canceled)

59. The system of claim 1, wherein the list is based on abundance of the at least one category of biological object in previous years at the observation time or date at the geographical location of the user.

60. The system of claim 1, wherein the list is based on a spatial or temporal correlation of the at least one category of biological object with at least one other category of biological object that is known to occur at the geographical location of the user at the observation time or date.

61. The system of claim 1, wherein the list is based on a spatial or temporal correlation of the at least one biological object with at least one of habitat, microclimate and weather, and preference.

62. The system of claim 1, further comprising allowing the user to modify, control or limit the information included in the list.

63. The system of claim 1, wherein the information included in the list is limited to biological objects not recorded by the user.

64. The system of claim 1, wherein the information included in the list is limited to biological objects recorded by the user.

65. The method of claim 18 further comprising accepting numerical information associated with the at least one category of biological object the numerical information including a count, a percentage, or a rating.

66. The method of claim 65, further comprising requesting additional information or confirmation if the associated numerical information is less than or greater than a threshold value, wherein the threshold value is determined by at least one of an adaptive process and a real-time process or based upon an adaptive process that uses information about the spatial or temporal correlations of the occurrence of biological objects recently reported by the user with the occurrence of other biological objects, wherein the additional information or confirmation includes at least one of: was obtained in real-time, was provided by the user, and was provided using at least one alpha-numeric character, icon or a voice command.

67. The method of claim 18, further comprising generating an electronic record including the user input and transmitting the generated electronic record to at least one remote network element using an electronic communication system, wherein the user input includes at least one of an alpha-numeric character, an icon and a voice command, or wherein items in the list of categories of biological objects are arranged in accordance with an increasing or decreasing likelihood of occurrence, or wherein items in the list of categories of biological objects are arranged in accordance with likelihood of occurrence that is greater than or less than a threshold value, or wherein the list is generated in real-time, or wherein the list is provided to the user in real-time, or wherein the list is generated in response to at least one alpha-numeric character, icon or voice command provided by the user, or wherein the system is configured to accept user input authorizing sharing at least a portion of the information included in the electronic record with one or more different users or an electronic database.

68. The method of claim 18, wherein the list is based on abundance of the at least one category of biological object in previous years at the observation time or date at the geographical location of the user.

69. The method of claim 18, wherein the list is based on a spatial or temporal correlation of the at least one category of biological object with at least one other category of biological object that is known to occur at the geographical location of the user at the observation time or date.

70. The method of claim 18, wherein the list is based on a spatial or temporal correlation of the at least one biological object with at least one of habitat, microclimate and weather, and preference.

71. The method of claim 18, wherein the information included in the list is limited to biological objects not recorded by the user.

72. The system of claim 18, wherein the information included in the list is limited to biological objects recorded by the user.
